(19) United States
(12) Patent Application Publication
(10) Pub. No.: US 2013/0085944 A1
(43) Pub. Date: Apr. 4, 2013

(54) SYSTEM AND METHOD FOR APPLICATION SECURITY

(71) Applicant: Guy Fielder, Austin, TX (US)

(72) Inventor: Guy Fielder, Austin, TX (US)

(73) Assignee: PACid Technologies, LLC, Austin, TX (US)

(21) Appl. No.: 13/592,745

(22) Filed: Aug. 23, 2012

Related U.S. Application Data
(60) Provisional application No. 61/540,771, filed on Sep. 29, 2011.

(51) Int. Cl. G06Q 20/38

(52) U.S. Cl. 705/67

(57) ABSTRACT

A secured hardware token includes an embedded processor, secured persistent storage, and read only memory. The storage includes functionality to store data that includes an account master secret for an account at a financial institution. The memory includes a security application, which causes the processor to receive, from a financial institution application executing on a mobile device, a call for an n-bit result. The security application further causes the processor to obtain, from the secured persistent storage, the account master secret, construct the n-bit result specific to the call using the account master secret and the n-bit generator input as input to an n-bit generator in the security application, and return the n-bit result to the financial institution application. The financial institution application provides the n-bit result to the financial institution, which completes a financial transaction when the n-bit result is verified using a copy of the account master secret.

### CROSS-REFERENCE TO RELATED APPLICATIONS

This application claims benefit under 35 U.S.C. §119(e) to U.S. Provisional Patent Application Ser. No. 61/540,771, filed on Sep. 29, 2011 and entitled, “System and Method for Application Security.” U.S. Provisional Patent Application Ser. No. 61/540,771 is incorporated herein by reference in its entirety.

### BACKGROUND

The computer system assists in managing (e.g., storing, organizing, and communicating) a large amount of information. Some of the information managed by a computer system is confidential. In other words, access to such information is intended to be limited. Traditional protection schemes attempt to prevent unauthorized users from accessing the confidential information by requiring that a user provide authentication credentials, at a predefined entry point, to access an account that includes the confidential information. Protecting only the predefined entry points, however, fails to account for nefarious individuals creating other entry points by exploiting computer system vulnerabilities. For example, knowledge of a user's hardware and software system, system configuration, types of network connections, etc., may be used to create an entry point and gain access to the confidential information.

In order to prevent unauthorized access to the confidential information, the confidential information may be encrypted. Encryption is a process of transforming the clear text confidential information into an encrypted format that is unreadable by anyone or anything that does not possess the encryption key for decrypting back to clear text. An encryption algorithm and an encryption key are used to perform the transformation. Encryption technology is classified into two primary technology types: symmetric encryption technology and asymmetric encryption technology. Symmetric encryption technology uses the same encryption key to both encrypt and decrypt information. Asymmetric encryption technology uses a pair of corresponding encryption keys: one encryption key to encrypt data and the other encryption key of the pair to decrypt the data.

### SUMMARY

In general, in one aspect, the invention relates to a secured hardware token for securing financial transactions. The secured hardware token includes an embedded processor, a secured persistent storage, and read only memory. The secured persistent storage includes functionality to store data that includes an account master secret for an account at a financial institution. The financial institution stores a copy of the account master secret in secured storage of the financial institution. The read only memory includes a security application, which, when executed by the embedded processor, causes the embedded processor to receive, from a financial institution application executing on a mobile device, a first call for a first n-bit result. The first call includes a first n-bit generator input and a first master secret identifier. The security application further causes the processor to obtain, from the secured persistent storage, the account master secret referenced by the first master secret identifier, construct the first n-bit result specific to the first call using the account master secret and the first n-bit generator input as input to an n-bit generator in the security application, and return the first n-bit result to the financial institution application. The financial institution application provides the n-bit result to the financial institution. The financial institution is adapted to complete a financial transaction when the first n-bit result is verified.

In general, in one aspect, the invention relates to a system for securing financial transactions. The system includes a mobile device and a secured hardware token. The mobile device includes a mobile device processor and memory. The memory includes a financial institution application, which, when executed by the mobile device processor, is configured to interact with a secured hardware token to obtain a first n-bit result, and provide the first n-bit result to a financial institution. The secured hardware token includes an embedded processor, a secured persistent storage, and read only memory. The secured persistent storage stores data that includes an account master secret for an account at the financial institution. The financial institution stores a copy of the account master secret in secured storage of the financial institution. The read only memory includes a security application, which, when executed on the embedded processor, causes the embedded processor to receive, from the financial institution application, a first call for the first n-bit result. The first call comprises a first n-bit generator input and a first master secret identifier. The financial institution application further causes the processor to obtain, from the secured persistent storage, the account master secret referenced by the first master secret identifier, construct the first n-bit result specific to the first call using the account master secret and the first n-bit generator input as input to an n-bit generator in the security application, and return the first n-bit result to the financial institution application. The financial institution application provides the n-bit result to the financial institution. The financial institution is adapted to complete a financial transaction when the first n-bit result is verified.

In general, in one aspect, the invention relates to a computer readable medium that includes computer readable program code for causing a computer system to engage, with a point of sale device, a communication session for a payment to a vendor, receive, from the point of sale device, a total monetary amount and a vendor identifier, combine the total monetary amount and vendor identifier into an n-bit generator input, and call, using the n-bit generator input and a master secret identifier for an electronic check as arguments, an n-bit generator executing on a secured hardware token. The master secret identifier references a master secret stored on the secured hardware token. The computer readable program code further causes the computer system to receive, from the n-bit generator, a check authentication code generated using the master secret and the n-bit generator input, create an electronic check by appending the check authentication code to the n-bit generator input, and send the electronic check to the point of sale device.

In general, in one aspect, the invention relates to a method for securing financial transactions. The method includes creating an account with a financial institution, and configuring, in response to creating the account, a secured hardware token to store an account master secret in a secured persistent storage. The financial institution stores a copy of the account master secret in secured storage of the financial institution. The method further includes providing, to a mobile device, a financial institution application. The financial institution application includes functionality to interact with the secured hardware token to obtain a first n-bit result, and provide the first n-bit result to the financial institution. The secured hardware token includes functionality to receive, from the financial institution application executing on the mobile device, a first call for the first n-bit result. The first call includes a first n-bit generator input and a first master secret identifier. The secured hardware token further includes functionality to obtain, from the secured persistent storage on the secured hardware token, the account master secret referenced by the first master secret identifier, construct, by an n-bit generator executing on the secured hardware token, the first n-bit result specific to the first call using the account master secret and the first n-bit generator input as input to the n-bit generator, and return the first n-bit result to the financial institution application. The financial institution completes a financial transaction when the first n-bit result is verified.

Other aspects of the invention will be apparent from the following description and the appended claims.

### BRIEF DESCRIPTION OF DRAWINGS

FIGS. 1-3 show systems in one or more embodiments of the invention.

FIGS. 4A-4C show example n-bit generator inputs in one or more embodiments of the invention.

FIGS. 5-15 show flowcharts in one or more embodiments of the invention.

FIG. 16 shows an example in one or more embodiments of the invention.

### DETAILED DESCRIPTION

Specific embodiments of the invention will now be described in detail with reference to the accompanying Figures. Like elements in the various Figures are denoted by like reference numerals for consistency. In the Figures, three co-linear dots indicate that additional items of similar type to the preceding and succeeding items with respect to the dots may optionally exist.

In the following detailed description of embodiments of the invention, numerous specific details are set forth in order to provide a more thorough understanding of the invention. However, it will be apparent to one of ordinary skill in the art that the invention may be practiced without these specific details. In other instances, features known by those of ordinary skill in the art have not been described in detail to avoid unnecessarily complicating the description.

In general, embodiments of the invention provide a method and system for application security. Specifically, embodiments of the invention combine a secured hardware token with a mobile device. The secured hardware token includes an n-bit generator and at least one master secret for each application executing on the mobile device. An application executing on the mobile device calls the n-bit generator with an n-bit generator input and an identifier of a corresponding master secret. The n-bit generator identifies the corresponding master secret, combines the n-bit generator input with the corresponding master secret and generates an n-bit result. The n-bit result is provided to the application. The application may use the n-bit result to, by way of an example, but not a limitation, verify information from another system, receive communications from another system securely, send information to another system securely, or validate previously stored information. Specifically, the other system may include the same master secret and n-bit generator to generate an n-bit result, which may be used, for example, for data validation and/or symmetric encryption. In one or more embodiments of the invention, once stored, the master secret is not exposed outside of the secured hardware token. Moreover, the n-bit result may vary with each usage. Thus, the use of the secured hardware token may provide a unique security solution for a variety of different applications. Additionally, the secured hardware token may provide a unique security solution for each use of the same application.

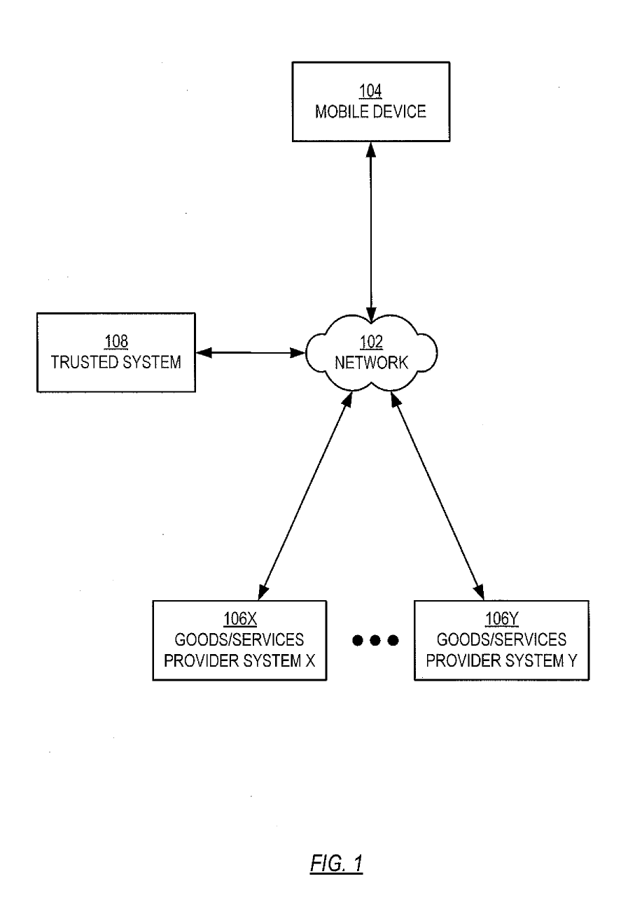

FIGS. 1-3 show systems in one or more embodiments of the invention. Turning to FIG. 1, FIG. 1 shows a communication system in one or more embodiments of the invention. As shown in FIG. 1, the communication system may include a network (102), a mobile device (104), a goods/services provider (e.g., goods/services provider X (106X), goods/services provider Y (106Y)), and a trusted system (108). Each of these components is described below.

In one or more embodiments of the invention, a network (102) is an interconnection of computing and storage devices that provides for the sharing of data. In particular, the network (102) includes functionality to transmit signals from a source to at least one destination. For example, the network (102) may be a local area network (LAN), a wide area network (WAN), such as the Internet or telecommunications network, or any other type of wired and/or wireless network.

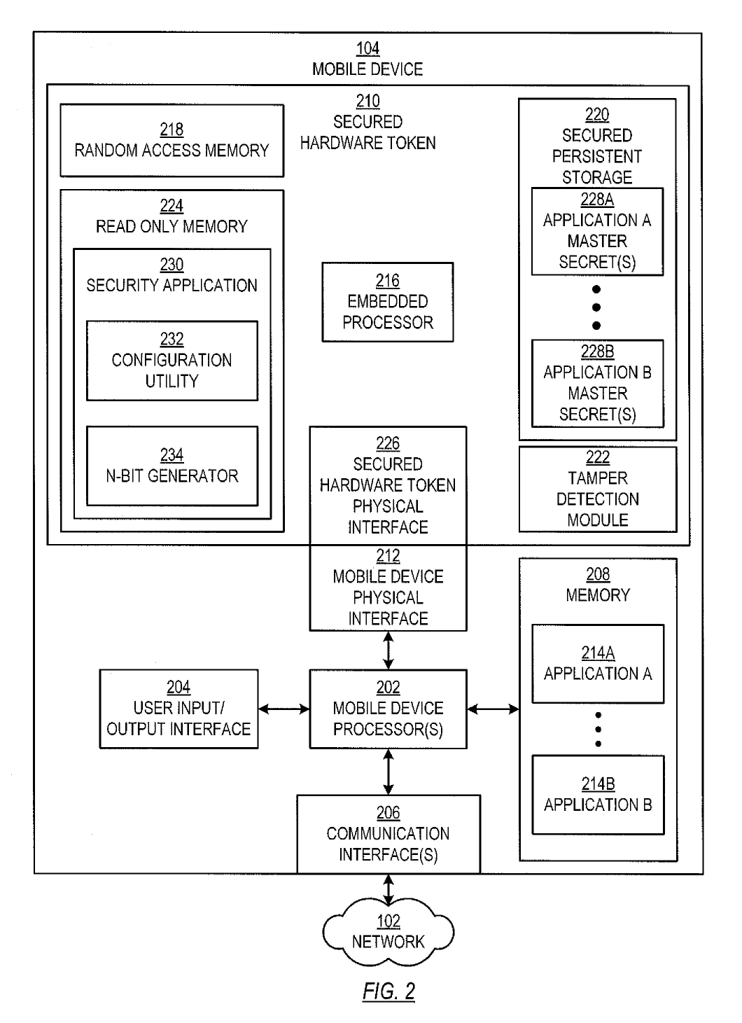

In one or more embodiments of the invention, a mobile device (104) is any type of portable device that includes functionality to connect to a network (102) and execute one or more applications (discussed below with reference to FIG. 2). A device is a piece of physical electronic equipment designed to perform at least one function. For example, the mobile device may be a smart phone, an electronic reader, a tablet or pad, a portable music player, or any other portable device. In one or more embodiments of the invention, the mobile device is pocket size. In other words, the mobile device is less than six inches by six inches in size. However, the mobile device may be larger in alternative embodiments of the invention. In one or more embodiments of the invention, the mobile device (104) is used by a user. Specifically, a user may be any individual or group of individuals that may access and select features on the mobile device. In one or more embodiments of the invention, the user is a holder of the mobile device. Specifically, the user has physical possession of the mobile device in one or more embodiments of the invention. The components of the mobile device (104) are discussed below and in FIG. 2.

As shown in FIG. 2, the mobile device includes at least one mobile device processor (202), user input/output interfaces (204), communication interfaces (206), memory (208), a secured hardware token (210), and a mobile device physical interface (212). Each of these components is described below.

In one or more embodiments of the invention, mobile device processor(s) (202) correspond to one or more physical processing units configured to execute instructions. Specifically, the mobile device processor(s) is hardware that is configured to execute instructions for the mobile device. For example, the mobile device processor(s) may be a central processing unit for the mobile device, an embedded processor(s), and/or one or more processor core(s).

In one or more embodiments of the invention, a user input/output interface (204) corresponds to interface(s) that include functionality to receive input and present information to a user. For example, the user input/output interface may correspond to hardware and/or software buttons, a touch screen, a display device, a keyboard, microphone, voice recognition software, speakers, biometric scanner, and/or any other component of a mobile device to transmit or receive information from a user.

In one or more embodiments of the invention, a communication interface (206) is an interface to connect to the network (102). By way of an example, and not a limitation, the communication interface (206) may be a Bluetooth interface, a telecommunications interface, a wireless network interface, a wired interface, or any other type of interface to connect to a network.

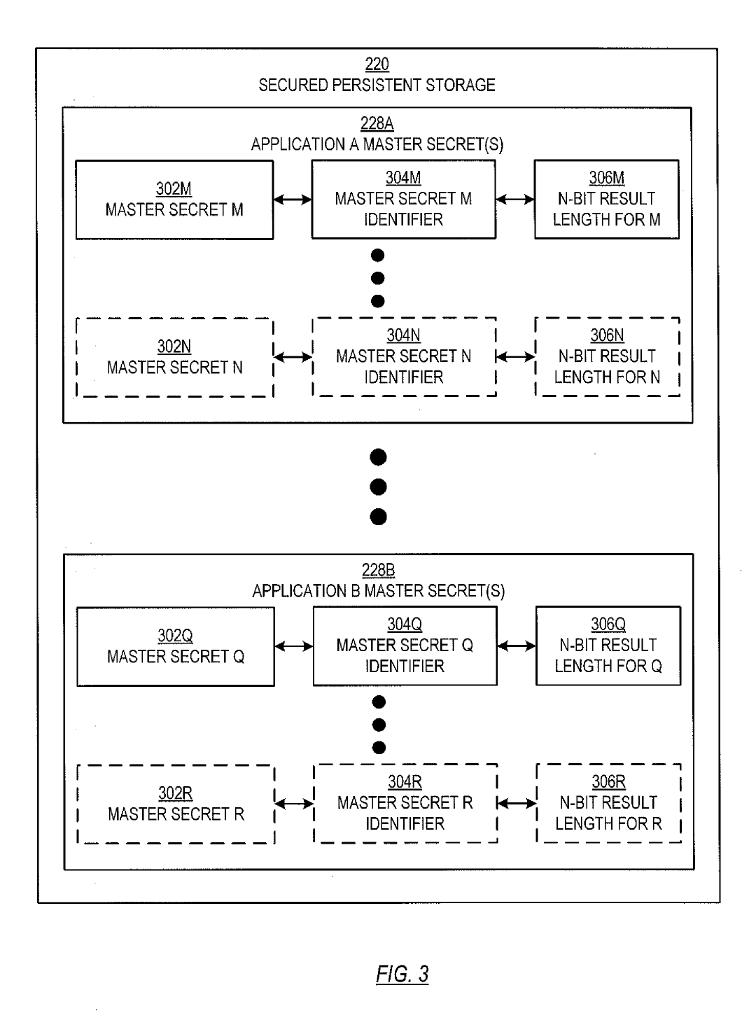

In one or more embodiments of the invention, memory (208) may correspond to one or more volatile and/or nonvolatile devices for storing information, such as instructions and data. In one or more embodiments of the invention, the memory (208) includes functionality to store applications (e.g., application A (214A), application B (214B)). Each application corresponds to a set of instructions for processing data. In one or more embodiments of the invention, each application, when executed, includes functionality to generate an n-bit generator input (discussed below and in FIG. 3) specific to the application, transmit a call to the secured hardware token (210), receive an n-bit result from the secured hardware token (210), create a communication using the n-bit result, and transmit the communication via the communication interface (206). In one or more embodiments of the invention, the call is a request using an application programming interface of the secured hardware token. In one or more embodiments of the invention, the call includes arguments. The arguments include the n-bit generator input and an identifier of a master secret (e.g., application A master secret(s) (228A), application B master secret(s) (228B)).

For example, the application(s) (e.g., application A (214A), application B (214B)) may include one or more of the following types of applications: a financial institution application, an electronic check application, a physical access application, a digital rights management application, an electronic notary application, a cloud access application, or any other type of application.

In one or more embodiments of the invention, a financial institution application includes functionality to communicate with a financial institution system, initiate a transfer of funds, present a list of financial transactions to a user, present account balance(s) to the user, assist the user to pay bills to other business entities, and/or perform other financial operations.

In one or more embodiments of the invention, an electronic check application includes functionality to assist the user in purchasing goods/services from a vendor. Specifically, the electronic check application includes functionality to interact with a point of sale device of a vendor and the secured hardware token, generate an electronic check to pay the vendor, and transmit the electronic check to the vendor. In one or more embodiments of the invention, an electronic check is an electronic form of payment that performs the same function as a paper check. In one or more embodiments of the invention, the electronic check includes an electronic check authentication code. The electronic check authentication code is a pseudo-random sequence of bits that allows a financial institution to confirm the validity of the electronic check. In one or more embodiments of the invention, the authentication code may be the functional equivalent of an electronic signature.

In one or more embodiments of the invention, a physical access application is an application configured to interact with the secured hardware token and a security interface of a tangible item in order to provide the user with physical access to, including use of, the tangible item. For example, the tangible item may be a house, a car, a room, a safe, a garage, or another protected item. The security interface may be a lock, an opener device, an alarm, an ignition switch, or other interface that controls access to the tangible item. The physical access application includes functionality to provide the security interface with an entry authentication code. In one or more embodiments of the invention, the entry authentication code is a pseudo-random sequence of bits that may be verified by the security interface to authenticate the user.

In one or more embodiments of the invention, the digital rights management application is an application that includes functionality to control access to digital content. Specifically, the digital rights management application may include functionality to control access to digital content based on the identity of the user. In one or more embodiments of the invention, the digital rights management application may include a media player (e.g., an audio/video player, electronic book application, or a player of another type of media) or may directly or indirectly interface with a media player.

In one or more embodiments of the invention, an electronic notary application is an application that allows the user to function as a notary for electronic documents. Specifically, after the user verifies the authenticity of a document in a file, the electronic notary may include functionality to add an electronic notary seal to the file. The electronic notary seal is a pseudo-random sequence of bits that is specific to the content of the file and to the user. Thus, if the file changes or the user did not authenticate the document, then the pseudo-random sequence will fail verification.

In one or more embodiments of the invention, a cloud access application is an application that includes functionality to interact with the secured hardware token and a cloud system to provide a user access to data on the cloud system. A cloud system is a system remote from the mobile device that may be accessed via the network. In one or more embodiments of the invention, the cloud system may be storage servers. Further, in one or more embodiments of the invention, the cloud system may store specific types of data, such as a user's media content, a user's health history, and the user's secured files. The cloud access application includes functionality to obtain an authentication code from the secured hardware token and present the authentication code to the cloud system. The cloud access application further includes functionality to receive data from the cloud system based on the verification of the authentication code. In one or more embodiments of the invention, the cloud access application may include functionality to directly or indirectly present the data to the user.

The aforementioned applications are only examples of possible applications that may execute on the mobile device. Further, the above identifies separate applications in accordance with the functionality performed. The same software product may include a single or multiple applications. For example, a financial software product may include both the financial institution application and the electronic check application. In such a scenario, a user may load the same software product onto the mobile device and select different menu options to access the different applications. Alternatively or additionally, the functionality performed by an application may be performed by multiple separate software products.

Continuing with FIG. 2, in one or more embodiments of the invention, the secured hardware token (210) is a physical device that is easily removable from the mobile device. For example, the secured hardware token (210) may be an external dongle or an internal card, such as a memory card. In one or more embodiments of the invention, an external dongle is any small tangible module that plugs in and sticks out of a socket. In one or more embodiments of the invention, the secured hardware token (210) includes an embedded processor (216), random access memory (218), secured persistent storage (220), a tamper detection module (222), read only memory (224), and a secured hardware token physical interface (226).

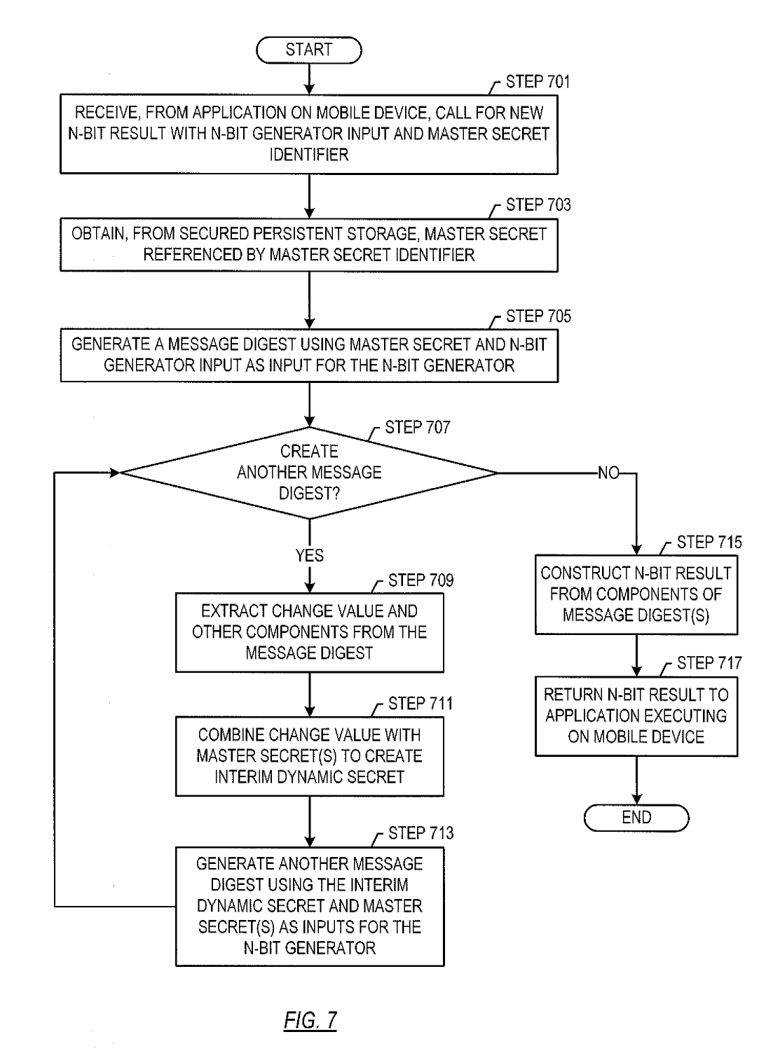

The embedded processor (216) corresponds to hardware logic configured to process instructions. The embedded processor (216) may be a general-purpose hardware processor, may be designed to perform only the tasks of the secured hardware token (210), or may be designed to perform only a subset of tasks that a general-purpose hardware processor can perform. In one or more embodiments of the invention, random access memory (218) is a memory module for temporary storage of data, such as generated message digests, interim secrets, and change values (discussed below with reference to FIG. 7).

The secured persistent storage (220) corresponds to a persistent storage (e.g., non-volatile) that is secured physically and/or electronically from unauthorized access. Data may be written to and read from the secured persistent storage. An example of physical security of the secured persistent storage (220) may correspond to detection of physical tampering of the secured persistent storage (220) by the tamper detection module(s) (222). Depending on the type of tamper detection implemented by the token, the token may include one or more tamper detection modules. Examples of electronic security of the secured persistent storage may correspond to (i) encryption of data stored in the secured persistent storage; and (ii) monitoring of access attempts (e.g., how many times incorrect Token Access Codes (TACs) were submitted to the token), etc. The electronic security may be implemented by the secured hardware token (210) (in particular the operating system or application stored on the secured hardware token (discussed below)).

Regardless of what attempts are used to breach the security measures of the token, the detection of an attempt or actual breach (physical and/or electronic) may result in (i) rendering the secured persistent storage physically inaccessible and/or (ii) clearing (or otherwise rendering unusable) the content of the secured persistent storage. The tamper detection module(s) (222) are configured to implement one or more of the above responses based on a detection of an attempted (or actual) breach.

In one or more embodiments of the invention, the data in the secured persistent storage are master secrets (e.g., application A master secret (228A), application B master secret (228B)) for each application. Specifically, each application (e.g., application A (214A), application B (214B)) on the mobile device may include at least one separate and unique corresponding master secret. In other words, different applications do not use the same master secret. A master secret is a random or pseudo-random sequence of bits that is not exposed outside of the secured hardware token (210). In some embodiments of the invention, the only exposure of a master secret may be through a secured communication channel in the process of an initial configuration. In other embodiments of the invention, the master secret is never exposed outside of the secured hardware token (210).

Continuing with the secured hardware token (210), in one or more embodiments of the invention, read only memory (224) is a memory module configured to store a security application (230). The security application (230) may be a small program configured to perform the functionality of the secured hardware token. Specifically, the security application (230) may include a configuration utility (232) and an n-bit generator (234). Although not shown in FIG. 2, the security application may alternatively be implemented in hardware.

In one or more embodiments of the invention, the configuration utility (232) includes functionality to store new master secrets in secured persistent storage. For example, the configuration utility may include functionality to interact with an application, an external device (not shown), or a user to assist in the generation and/or storage of a new master secret. The configuration utility may further include functionality to initialize the secured hardware token for the user. For example, the configuration utility may include functionality to obtain new credentials (e.g., biometric data, a token authorization code) that allows the user to use the secured hardware token while preventing nefarious individuals from accessing the secured hardware token.

In one or more embodiments of the invention, an n-bit generator (234) includes functionality to receive and process one or more inputs to generate an n-bit result composed of one or more message digests. In one or more embodiments of the invention, the inputs to the n-bit generator (234) include an n-bit generator input (provided by an application) and a master secret or an identifier of a master secret. In one or more embodiments of the invention, if the input is an identifier of a master secret, the n-bit generator includes functionality to obtain the corresponding master secret from the secured persistent storage.

In one or more embodiments of the invention, a message digest is a string of characters, which may be represented as a bit-string. In one or more embodiments of the invention, the message digest is a bit string. Further, the n-bit generator includes functionality to generate a deterministic and repeatable message digest, which appears pseudo-random or random, in accordance with one or more embodiments of the invention. A pseudo-random output (e.g., message digest) is an output that is repeatable and predictable but appears random. Specifically, in one or more embodiments of the invention, although the message digest is repeatable and calculable when the inputs, master secret, and the operations performed by the n-bit generator (234) are known, the message digest appears random to anyone who does not know these inputs. The apparent randomness may be with respect to someone who knows or does not know all the inputs in accordance with one or more embodiments of the invention. Alternatively, or additionally, the apparent randomness may be with respect to someone who does not know the operations performed by the n-bit generator in accordance with one or more embodiments of the invention. In one or more embodiments of the invention, the message digest is deterministic in that a single output exists for a given set of inputs.

Moreover, the message digest may be a fixed length. In other words, regardless of the input length, the same n-bit generator (234) may produce a message digest with a fixed length. The n-bit generator (234) may include functionality to concatenate multiple generated message digests together to generate the n-bit result. The length of the n-bit result is configurable by the application (e.g., application A (214A), application B (214B)) in one or more embodiments of the invention.

The number of bits in the input to the n-bit generator may be different or the same as the number of bits in the output produced by the n-bit generator. For example, if the n-bit generator accepts n number of bits for input and produces m number of bits for output, m may be less than, equal to, or greater than n. Multiple iterations of the n-bit generator may be performed to construct an ever-increasing n-bit result that includes multiple message digests.

Further, the n-bit generator (234) includes functionality to generate a deterministic message digest. Specifically, the n-bit generator (234) has the following two properties. First, the n-bit generator (234) generates the same message digest when provided with the same input(s). Second, the n-bit generator generates, with a high probability, a different message digest when provided with different input(s). For example, a single bit change in the input may result in a significant change of the bits in the resulting message digest. By way of an example, the change may be fifty percent of the bits depending on the type of n-bit generator used. However, a greater percentage or lesser percentage of bits may change without departing from the scope of the invention.

The n-bit generator (234) may include multiple sub-routines, such as a bit shuffler (not shown) and a hash function (not shown). In one or more embodiments of the invention, the bit shuffler includes functionality to combine multiple inputs into a single output. Specifically, the bit shuffler applies a function to the bit level representation of inputs to generate a resulting set of output bits. The output of the bit shuffler may appear as a shuffling of bits in each of inputs and may or may not have the same ratio of l′s to 0′s as the input. In one or more embodiments of the invention, the bit shuffling by the bit shuffler has a commutative property. In other words, the order that inputs are provided to the bit shuffler does not affect the output. For example, consider the scenario in which the inputs are input X, input Y, and input Z. Bit shuffling on input X, input Y, and input Z produces the same output as bit shuffling on input Y, input Z, and input X.

In one embodiment of the invention, the bit shuffler may correspond to any function or series of functions for combining inputs. For example, the bit shuffler may correspond to the XOR function, the multiplication function, an addition function, another function, or a combination of functions that may be used to combine inputs. As another example, the bit shuffler may correspond to a function that orders the inputs and then uses a non-commutative function to generate an output. The bit shuffler may correspond to other mechanisms for combining multiple inputs without departing from the scope of the invention.

In one or more embodiments of the invention, a hash function is a function that includes functionality to receive an input and produce a pseudo-random output. In one or more embodiments of the invention, the hash function may include functionality to convert a variable length input into a fixed length output. By way of an example, and not a limitation, the hash function may correspond to GOST, HAVAL, MD2, MD4, MD5, PANAMA, SNEERU, a member of the RIPEMD family of hash functions, a member of the SHA family of hash functions, Tiger, Whirlpool, S-Box, P-Box, any other hash function, or any combination thereof.

Although the above description discusses the use of the bit shuffler prior to the hash function, in one or more embodiments of the invention, the hash function operations may be performed prior to the bit shuffler operations. For example, the hash function may be performed separately on each of the inputs to create hashed inputs. The hashed inputs may then be combined by the bit shuffler. Alternatively, the bit shuffler may first be performed on the inputs to create a single intermediate result before the intermediate result is provided to the hash function. The intermediate result may be stored to be used later to create subsequent message digests.

Continuing with FIG. 2, in one or more embodiments of the invention, the secured hardware token physical interface (226) is a direct hardware connection to the mobile device physical interface (212). The secured hardware token physical interface (226) and mobile device physical interface (212) may be an industry standard interface or a proprietary interface. For example, the secured hardware token physical interface (226) and mobile device physical interface (212) may be a universal serial bus (USB) (including mini-USB, micro-USB, and other USB) port and corresponding connector, a memory card port (e.g., a Secured Digital (SD) memory card port) and corresponding connector, or another such port and connector.

Returning to FIG. 1, in one or more embodiments of the invention, a goods/services provider (e.g., goods/services provider X (106X), goods/services provider Y (106Y)) is an entity that provides goods and/or services to the user of the mobile device (104). The goods/services provider (e.g., goods/services provider X (106X), goods/services provider Y (106Y)) may include hardware, firmware, and/or software to establish a secure communication, secure data for the user, and/or verify data from the user. The goods/services provider (e.g., goods/services provider X (106X), goods/services provider Y (106Y)) may further include components of a business entity, such as buildings, people, and other such components. In one or more embodiments of the invention, the goods/services provider (e.g., goods/services provider X (106X), goods/services provider Y (106Y)) may include a kiosk for allowing a user to configure a secured hardware token with one or more master secrets.

In one or more embodiments of the invention, each goods/services provider (e.g., goods/services provider X (106X), goods/services provider Y (106Y)) includes at least one corresponding application on the mobile device (104). The corresponding application(s) provides the user-facing functionality specific to the goods/services provider (e.g., goods/services provider X (106X), goods/services provider Y (106Y)). For example, the corresponding application for a financial institution may be a financial institution application that communicates with the financial institution and obtains an account balance, financial transactions, and other such information to present to the user. The financial institution may also have a corresponding electronic check application for executing on the mobile device to allow the user to create electronic checks against the user's account at the financial institution. As another example, an e-commerce goods/services provider may have an e-commerce application for execution on the mobile device. In one or more embodiments of the invention, the goods/services provider provides the corresponding application to the mobile device (104), such as directly or through an online market for the mobile device.

In one or more embodiments of the invention, the goods/services provider (e.g., goods/services provider X (106X), goods/services provider Y (106Y)) includes an account for the user. Along with other relevant account information, such as a user identifier, the account may include a copy of the one or more master secret(s) for the corresponding application(s) that are stored on the user's secured hardware token. In other words, each goods/services provider (e.g., goods/services provider X (106X), goods/services provider Y (106Y)), may have a copy of the related separate and unique set of one or more master secrets on the secured hardware token of the mobile device. The copy of the master secret(s) allows the goods/services provider (e.g., goods/services provider X (106X), goods/services provider Y (106Y) of FIG. 1) to authenticate that data purporting to be authorized by the user and received from the mobile device is, in fact, authorized and from the mobile device.

In one or more embodiments of the invention, once configured, the master secret associated with the configuration is stored in a secured storage on both the secured hardware token and at the goods/services provider (e.g., goods/services provider X (106X), goods/services provider Y (106Y) of FIG. 1). Moreover, the master secret is not exposed outside of either the goods/services provider or the secured hardware token. Thus, the master secret provides an authentication mechanism for data from the user. In one or more embodiments of the invention, the master secret is used solely as a secret input to the n-bit generator whereby the token can generate or recreate a pseudo-random message digest to be employed by the application for purposes of security.

Although not shown in FIG. 1, the goods/services provider may include an application server and a token server. The token server may include the same or similar functionality as the secured hardware token on the mobile device. Specifically, the token server may include the secured storage for storing master secrets of various users. The token server may additionally include a security application having an n-bit generator. The application server may include functionality to receive requests or transactions regarding one or more users and perform server side functionality to process the requests or transactions. The application server may include functionality to interact with the token server similar to the applications on the mobile device interacting with the secured hardware token.

Continuing with FIG. 1, the trusted system (108) corresponds to an intermediary between the goods/services provider (e.g., goods/services provider X (106X), goods/services provider Y (106Y)) and the mobile device (104). Specifically, the trusted system (108) is an entity that is trusted by both the goods/services provider (e.g., goods/services provider X (106X), goods/services provider Y (106Y)) and the user of the mobile device (104). For example, the trusted system (108) may act as an introducer of the user to the goods/services provider (e.g., goods/services provider X (106X), goods/services provider Y (106Y)) and the goods/services provider (e.g., goods/services provider X (106X), goods/services provider Y (106Y)) to the user. Moreover, the trusted system (108) may include functionality to build and/or locally or remotely configure the secured hardware token (210 of FIG. 2). Additionally, the trusted system (108) may include a public-key repository that ties a public-key to a secured hardware token (210) serial number. Applications for a symmetric encryption system are detailed below.

Although not shown in FIGS. 1 and 2, various components of FIGS. 1 and 2 may be implemented in software and/or firmware. Thus, computer readable program code to perform one or more of the various components may be stored, permanently or temporarily, in whole or in part, on a computer readable medium such as a compact disc (CD), a diskette, a tape, physical memory, or any other physical computer readable storage medium that includes functionality to store computer readable program code to perform embodiments of the invention. In one embodiment of the invention, the computer readable program code is configured to perform embodiments of the invention when executed by a processor(s).

Although not shown in FIGS. 1 and 2, rather than a secured hardware token, the functionality of the secured hardware token may be performed on a single core of a multi-core processor on the mobile device. Specifically, the single core may be a dedicated core that is dedicated to performing only the functions of the security application. The single core may include a private interface to secured persistent storage on the mobile device, where the secured persistent storage is not accessible by any other core or common buss. One or more of the remaining cores may execute the applications of the mobile device discussed above with reference to FIG. 2.

FIG. 3 shows a schematic diagram of the secured persistent storage (220) on the secured hardware token (210 of FIG. 2) in one or more embodiments of the invention. As shown in FIG. 3, the secured persistent storage (220) includes application master secrets (e.g., application A master secret(s) (228A), application B master secret(s) (228B)). The application master secrets (e.g., application A master secret(s) (228A), application B master secret(s) (228B)) are a set of one or more master secrets (e.g., application A master secret(s) (228A), application B master secret(s) (228B)) for each application.

Each master secret (e.g., master secret M (302M), master secret N (302N), master secret Q (302Q), master secret R (302R)) has a corresponding master secret unique identifier (e.g., master secret M identifier (304M), master secret N identifier (304N), master secret Q identifier (304Q), master secret R identifier (304R)) and a corresponding n-bit result length (e.g., n-bit result for M (306M), n-bit result for N (306N), n-bit result for Q (306Q), n-bit result for R (306R)). In one or more embodiments of the invention, the master secret (e.g., master secret M (302M), master secret N (302N), master secret Q (302Q), master secret R (302R)) is in a one-to-one relationship with both the master secret unique identifier and the n-bit result length. The relationship between the master secret, the master secret unique identifier, and n-bit result may be maintained by any type of data structure or layout that may maintain relationships.

The master secret unique identifier is any alphanumeric identifier that uniquely identifies the master secret from other master secrets in the secured persistent storage. For example, the master secret identifier may be a numeric value, an identifier of the goods/services provider, an identifier of the application, or any other unique identifier. In one or more embodiments of the invention, the n-bit result length specifies length of the n-bit result when the master secret is used. For example, the n-bit result length may be a numeric quantity identifying the number of message digests to concatenate to obtain the n-bit result or the number of bits in the n-bit result.

Although not shown in FIG. 3, in addition to master secret(s) for each application, the secured persistent storage may include manufacturer's master secret(s). The manufacturer's master secret(s) may be configured on the secured hardware token, for example, by the trusted system and/or a manufacturer of the secured hardware token. Similar to other master secrets, the manufacturer's master secret(s) may be associated with a master secret identifier and an n-bit result length. By way of an example and not a limitation, manufacturer's master secret(s) might be used to configure a secured hardware token, perform administrative updates on a secured hardware token, to make a backup copy of the secured hardware token, and other functions.

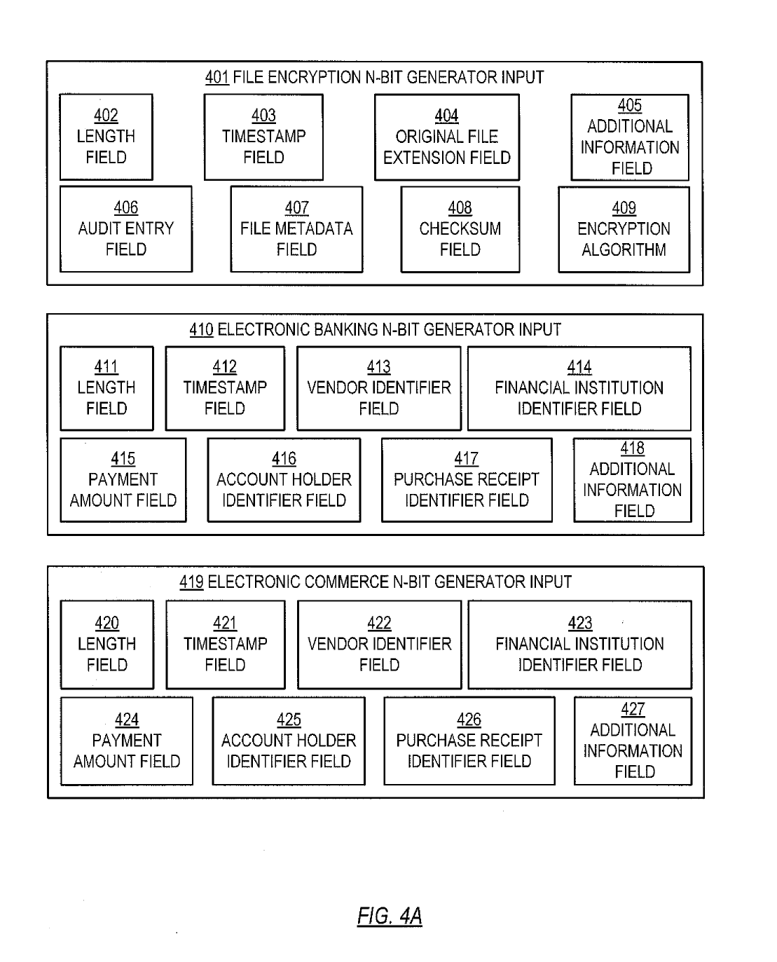

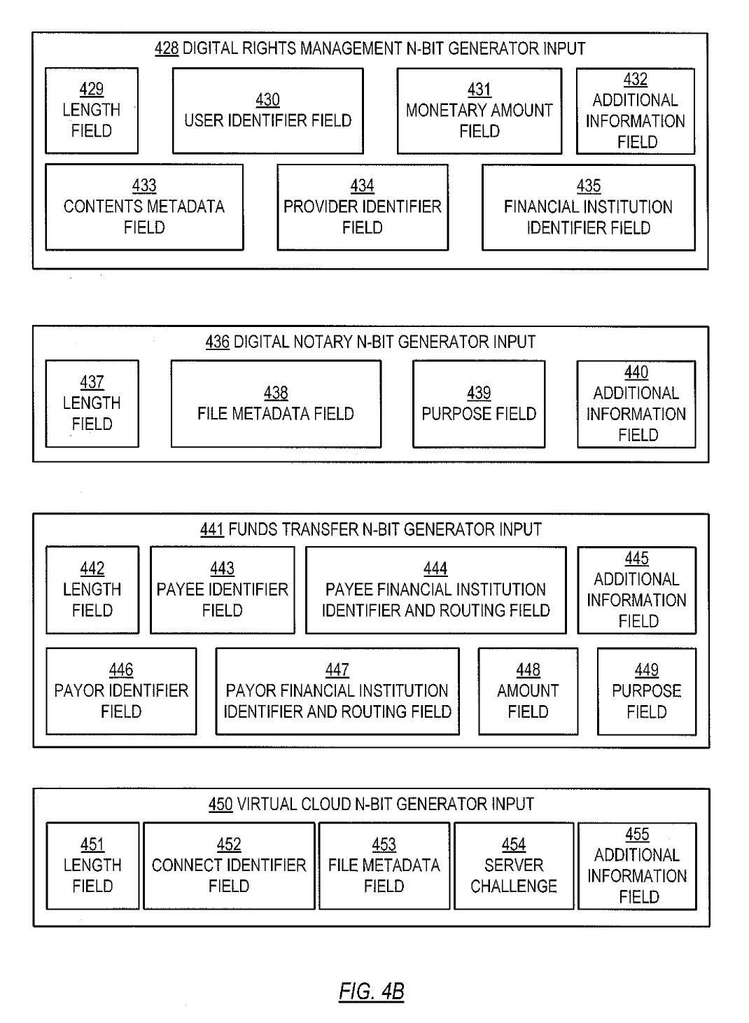

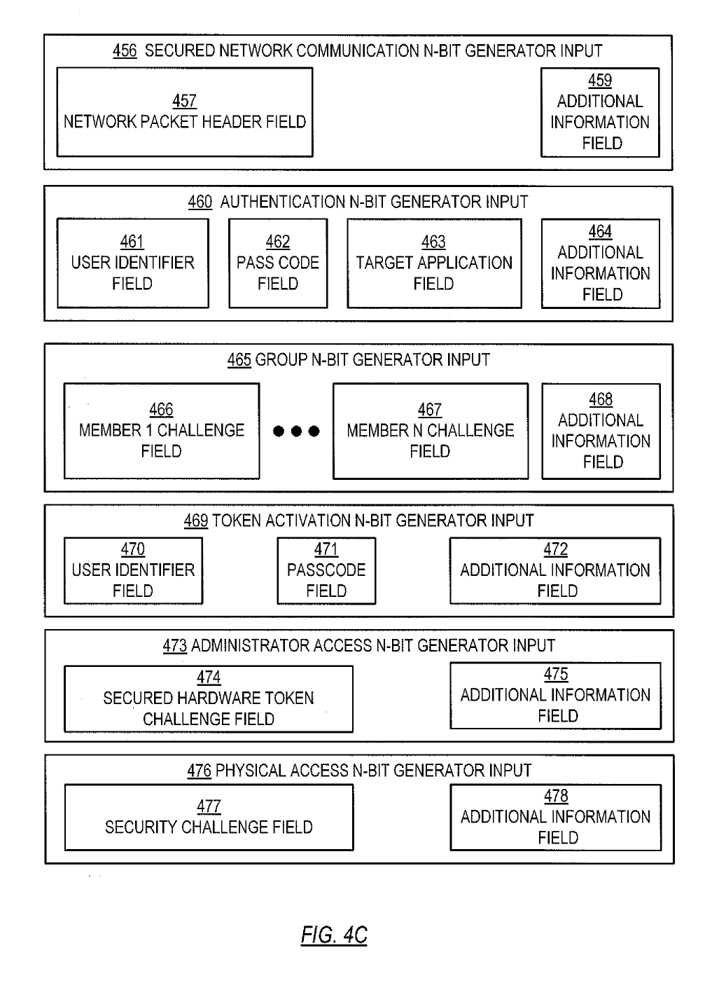

FIGS. 4A-4C show example n-bit generator inputs in one or more embodiments of the invention. The n-bit generator inputs shown in FIGS. 4A-4C are only examples and are not intended to limit the scope of the invention. Each n-bit generator input is a sequence of bits that has various defined fields. The sequence of bits may be presented to a user or passed between various components of FIGS. 1-3 in virtually any form, such as a bit string form, an alphanumeric sequence, etc. The ordering of the fields may be different from what is presented in FIGS. 4A-4C in alternative embodiments of the invention. Each field includes functionality to store a value in one or more embodiments of the invention. The sequence of bits used to store the value may be in accordance with a predefined format and/or protocol. For example, various different sequences of bits, in accordance with different protocols, may be used to represent the same time in a timestamp. Any of the sequences may be used without departing from the scope of the invention. Different mechanisms may be used to distinguish one field from another. For example, each field may have a predefined number of bits, a separate length field, and/or a special character or sequence of bits separator.

In one or more embodiments of the invention, the fields of the n-bit generator input are specific to the application and the use of the n-bit generator. In particular, the n-bit generator input encodes information about the operation. In one or more embodiments of the invention, the application executing on the mobile device may provide the n-bit generator input to the n-bit generator and/or a goods/services provider. For the n-bit generator, the n-bit generator input provides a mechanism for the n-bit result of the n-bit generator to be specific to a particular application. The n-bit generator input may be used by the applications to provide information regarding a communication or transaction and a mechanism to validate the authenticity of the specific communication or transaction.

Turning to FIG. 4A, a file encryption n-bit generator input (401) may be used to encrypt and decrypt a file. The file encryption n-bit generator input (401) may include one or more of the following: a length field (402), a timestamp field (403), an original file extension field (404), an additional information field (405), an audit entry field (406), a file metadata field (407), a checksum field (408), and an encryption algorithm field (409).

In one or more embodiments of the invention, the length field (402) stores an identifier of the number of bits in the file encryption n-bit generator input (401). The timestamp field (403) stores a date/time in which the request for the n-bit result is made in one or more embodiments of the invention. Thus, the timestamp field (403) allows for different n-bit results to be generated each time a new request is made. The original file extension field (404) is a field that defines the file extension of the original unencrypted version of the file. The additional information field (405) is an optional field that allows a goods/services provider to optionally add additional information to the n-bit generator input. Specifically, the additional information field may not exist, may be a single additional field, or may be multiple additional fields.

In one or more embodiments of the invention, the audit entry field (406) stores security tracking information. The audit entry field (406) includes information that the user is following a security policy and supports a security policy audit without resorting to exposing the file contents.

The file metadata field (407) may include metadata. Metadata is a set of data that describes and gives information about the file and the file contents in one or more embodiments of the invention. The file metadata field (407) may include the timestamps in which the file was created, accessed, and/or modified, the size of the file, author of the file, and/or any other information about the file. Including the metadata eliminates any need to decrypt the file to obtain the metadata.

In one or more embodiments of the invention, the checksum field (408) stores a value used to determine whether the file encryption n-bit generator input (401) has been intentionally or unintentionally modified. For example, the checksum may be generated using a hash function on the file encryption n-bit generator input (401). Alternatively, the checksum may be one of many error-correcting checksums, which would allow any modification to be reversed.

In one or more embodiments of the invention, the encryption algorithm field (409) is a field to specify the encryption algorithm used to encrypt the file. Alternatively, rather than the n-bit generator input including the encryption algorithm field (409), the encryption algorithm may be defined by the n-bit result.

Continuing with FIG. 4A, the electronic banking n-bit generator input (410) is an n-bit generator input that may be used in electronic banking, such as for an electronic check, or an electronic credit card payment request. In one or more embodiments of the invention, the electronic banking n-bit generator input (410) may include one or more of the following: a length field (411), a timestamp field (412), a vendor identifier field (413), a financial institution identifier field (414), a payment amount field (415), an account holder identifier field (416), a purchase receipt identifier field (417), and an additional information field (418).

The length field (411) is similar to the length field (402). In one or more embodiments of the invention, the additional information (418) performs the same function as the additional information (405). The timestamp field (412) stores a date and, optionally, a time of the financial transaction. The date in the timestamp field (412) may perform the same or similar function as a date on a physical paper check. The time may function to identify when the financial transaction occurred, such as for auditing purposes.

In one or more embodiments of the invention, the vendor identifier field (413) stores an identifier of the vendor with whom the user transacts. For example, for a particular transaction, the vendor may be the person or business entity to whom the user pays or from whom the user receives a refund. For example, the vendor identifier field (413) may be a merchant identifier or another identifier for the vendor. In one or more embodiments of the invention, the vendor identifier performs the same function as a payor field in a physical paper check.

In one or more embodiments of the invention, the financial institution identifier field (414) is an identifier of the financial institution having the user's financial account. The financial institution identifier identifies the financial institution that is holding the funds of the user and who will provide for the transfer of funds from the user's account to the vendor's account. For example, the financial institution identifier may be the same or similar to a bank routing number on a physical paper check.

The payment amount field (415) stores the amount that is to be transferred from the user's account to the vendor's account in one or more embodiments of the invention. Specifically, the payment amount is the agreed value of the transaction.

The account holder identifier field (416) stores an account holder identifier of the user. For example, the account holder identifier field (416) may store the user of the secured hardware token, the mobile device, and/or the user's account at the financial institution. In one or more embodiments of the invention, the account holder identifier is a value for identifying the user known to both an application executing on the mobile device and the financial institution. For example, the account holder identifier field may be the same or similar to a user's account number on a physical paper check.

The purchase receipt identifier field (417) stores a tracking value to directly or indirectly identify the transaction. For example, the purchase receipt identifier field (417) may store a list of items purchased, a description of the services provided, or other information. By way of an example of indirect identification, the purchase receipt identifier field may store a confirmation number or other identifier of a record having detailed information about the financial transaction. In such a scenario, the record may be maintained by the vendor, the financial institution, the mobile device, and/or another entity and accessed electronically as necessary or desired, such as in the case of issuing a refund.

Continuing with FIG. 4A, the electronic commerce n-bit generator input (419) is an n-bit generator input for performing electronic commerce transactions, such as purchasing goods/services using the Internet. The electronic commerce n-bit generator input (419) may include one or more of the following: a length field (420), a timestamp field (421), a vendor identifier field (422), a financial institution identifier field (423), a payment amount field (424), an account holder identifier field (425), a purchase receipt identifier field (426), and an additional information field (427). In one or more embodiments of the invention, the aforementioned fields store the same or similar information as the corresponding fields in the electronic banking n-bit generator input (410). By way of example and not limitation, electronic banking n-bit generator input (410) may be used to withdraw funds directly from the user's account much like a check or debit transaction; and, electronic commerce n-bit generator input (419) may be used to fund the transaction using a preapproved line of credit much like a credit card transaction.

Turning to FIG. 4B, the digital rights management n-bit generator input (428) is an n-bit generator input for authenticating a user to access digital content. Digital content may include, for example, electronic books, music, games, articles, or any other form of media content. The digital rights management n-bit generator input (428) may include one or more of the following: a length field (429), a user identifier field (430), a monetary amount field (431), an additional information field (432), a contents metadata field (433), a provider identifier field (434), and a financial institution identifier field (435). Each of these is described below.

The length field (429) and the additional information field (432) may perform a same or similar function as length field (402) and the additional information field (405), respectively, in FIG. 4A. The user identifier field (430) stores a unique identifier for the user. The unique identifier may be any form of identification that uniquely identifies the user. For example, the unique identifier may be the secured hardware token serial number. In one or more embodiments of the invention, the unique identifier identifies the user's account at a digital content provider.

In one or more embodiments of the invention, the monetary amount field (431) identifies the amount that a user paid for the digital content. The contents metadata field (433) stores information about the digital content. For example, the contents metadata field (433) may include the title, size, author, creation and modification timestamps, and/or other information about the digital content. By including the contents metadata field (433), an n-bit result generated using the digital rights management n-bit generator input is unique to the particular digital content.

The provider identifier field (434) identifies the goods/services provider that provides the digital content to the user. For example, the goods/services provider may be the entity from which the user purchased or obtained rights to access the digital content. The financial institution field (435) may identify the financial institution and/or the financial account that the user used to purchase the digital content. Alternately, the financial institution field (435) may identify the financial institution and/or the financial account of the goods and services provider.

In one or more embodiments of the invention, although not shown in FIG. 4B, the digital rights management n-bit generator input (428) may also include one or more additional rental constraint fields for rental content. For example, the rental constraint fields may specify a number of times that the rental content may be presented and/or a time limit when the rental period expires. In a scenario where the content is downloaded for local storage, similar constraints may be included in the n-bit generator input to help ensure that any use is within the rights of use guidelines.

In one or more embodiments of the invention, the digital notary n-bit generator input (436) is an n-bit generator input for a user to act as a notary for digital content. Specifically, a user may verify the authenticity of an electronic document and affix a notary seal generated using the digital notary n-bit generator input to the electronic document. The digital notary n-bit generator input (436) may include one or more of the following: a length field (437), a file metadata field (438), a purpose field (439), and an additional information field (440).

The length field (437) and the additional information field (440) may perform a same or similar function as length field (402) and the additional information field (405), respectively, in FIG. 4A. The file metadata field (438) may perform a same or similar function for the file having the digital content as the file metadata field (407) in FIG. 4A. In one or more embodiments of the invention, if the file representing the document being notarized is encrypted, the file metadata field may be defined with respect to the encrypted and/or decrypted version of the file. The purpose field (439) is an optional field that allows a user to submit a reason for the notarization. For example, the purpose may be for passport application, verifying the name of the person who drafted the document, for a legal reason, or for another reason.

Continuing with FIG. 4B, the funds transfer n-bit generator input (441) is an n-bit generator input for a user to request the transfer of funds. Specifically, the funds transfer n-bit generator input (441) may be used by a user to request a transfer of funds from one account to another account. In one or more embodiments of the invention, the funds transfer n-bit generator input may include one or more of the following: a length field (442), a payee identifier field (443), a payee financial institution identifier and routing field (444), an additional information field (445), a payor identifier field (446), a payor financial institution identifier and routing field (447), an amount field (448), and a purpose field (449).

The length field (442) and the additional information field (445) may perform a same or similar function as length field (402) and the additional information field (405), respectively, in FIG. 4A. The payee identifier field (443) stores a unique identifier for the payee. For example, the payee identifier may be a user account number to which to transfer funds, a nickname for the payee, or another mechanism to identify the payee. The payee financial institution identifier and routing field (444) stores an identifier of the financial institution and the routing number of the bank having the payee's account.

The payor identifier field (446) stores a unique identifier for the payor. For example, the payor identifier field may be an account number to which to transfer funds, a nickname for the payor, or another mechanism to identify the payor. The payor financial institution identifier and routing field (447) stores an identifier of the financial institution and the routing number of the bank having the payor's account. The amount field (448) stores the monetary amount to transfer. The purpose field (449) is an optional field that allows a user to submit a purpose of the funds transfer, such as to pay a particular bill, identify good(s)/service(s) provided, etc.

In one or more embodiments of the invention, the virtual cloud n-bit generator input (450) is an n-bit generator input for the user to access a virtual cloud server. Specifically, the virtual cloud n-bit generator input assists in downloading secured content from a virtual cloud server. In one or more embodiments of the invention, the virtual cloud n-bit generator input (450) may include one or more of the following: a length field (451), a connect identifier field (452), a file metadata field (453), a server challenge field (454), and an additional information field (455).

The length field (451), the file metadata field (453), and the additional information field (455) may perform a same or similar function as length field (402), the file metadata field (407), and the additional information field (405), respectively, in FIG. 4A. The connect identifier field (452 of FIG. 4B) stores a connection identifier for the current connection between the user's mobile device and the cloud server. For example, the connection identifier may be a session identifier. Alternately, the connect identifier field may identify the user or the serial number of the secured hardware token which is requesting access. The server challenge field (454) stores a challenge value provided from the cloud server to the user's mobile device. Alternatively, the server challenge field (454) may store an answer to a challenge sent from the cloud server to the user's mobile device.

Turning to FIG. 4C, the secured network communication n-bit generator input (456) is an input value for use in performing secure network communications. Specifically, the secure network n-bit generator value may be used to generate different n-bit results that may be used as symmetric encryption solutions (e.g., an encryption key and/or an encryption algorithm identifier). The secure network n-bit generator input (456) may include a network packet header field (457) and an additional information field (459).

The network packet header field (457) stores the packet header for a particular network packet. In one or more embodiments of the invention, the packet header may include the packet destination and a sequence number of each packet with respect to the ordering of packets transmitted over the network. The additional information field (459) performs the same or similar function as the additional information field (405) in FIG. 4A.

The authentication n-bit generator input (460) may be used to authenticate a user to an application, such as to allow a user to use a particular application. The authentication n-bit generator input (460) may include one or more of the following: a user identifier field (461), a pass code field (462), a target application field (463), and an additional information field (464). The additional information field (464) may perform the same or similar function as the additional information field (405) discussed above with reference to FIG. 4A. The user identifier field (461) stores a unique identifier for the user. For example, the user identifier field (461) may store an email address, an alphanumeric character string, or any other identifier for the user. A pass code field (462) stores a user's password or passphrase. The target application field (463) stores a unique identifier for the target application that the user wants to access.

The group n-bit generator input (465) is an n-bit generator input for a group of one or more communicators to create a new master secret, or establish a secured communication session. For example, the group may be the user and a goods/services provider, the user and a set of the user's friends or coworkers, or another user group. The group is composed of two or more members. The group n-bit generator input (465) includes a challenge field (466, 467) for each member of the group and an additional information field (468). The challenge field (466, 467) stores a challenge that each member sends to other members of the group. For example, a member may send to each other member an alphanumeric string encrypted using the respective other members' public encryption key. The receiving member may decrypt the challenge using their private key and add the decrypted challenge to the n-bit generator input in the challenge field (466, 467) in accordance with a group agreed order of challenges. Alternately, since the bit shuffler may have commutative properties, the order may not matter. The additional information value (468) may perform the same or similar function as the additional information field (405) discussed above with reference to FIG. 4A.

In one or more embodiments of the invention, once the group has created and stored a shared master secret, future challenges may be sent in the clear (i.e., unencrypted). Each new occurrence would be preceded with new random challenges. The master secret is unknown to anyone outside the group so the new message digest generated for this session would be different from any previous session.

The token activation n-bit generator input (469) may be used to activate the secured hardware token. The token activation n-bit generator input (469) may include one or more of the following: a user identifier field (470), a pass code field (471), and an additional information field (472). The user identifier field (470), pass code field (471), and additional information field (472) may perform the same or similar function as the similarly named fields of the authentication n-bit generator input (460).

The administrator access n-bit generator input (473) may be used by the trusted system to obtain access to administrator functions on the secured hardware token. The administrator access n-bit generator input (473) may include a secured hardware token challenge field (474) and an additional information field (475). The secured hardware token challenge field (474) contains a random challenge that is sent to the trusted system to be inputted into the n-bit generator along with the trusted master secret to authenticate the trusted system to the secured hardware token. The additional information field (475) may perform a same or similar function as the additional information field (405) in FIG. 4A. For example, the trusted system may also include a random challenge that is added to the administrator access n-bit generator input (473) in addition to the secured hardware token challenge (474).

The physical access n-bit generator input (476) may be used to obtain access to a tangible item. The physical access n-bit generator input may include one or more of the security challenge field (477) and an additional information field (478). The security challenge field (477) is a randomly generated challenge issued by the security interface to the tangible item. For example, the challenge may be a randomized alphanumeric character string. The additional information field (478) may perform a same or similar function as the additional information field (405) in FIG. 4A.

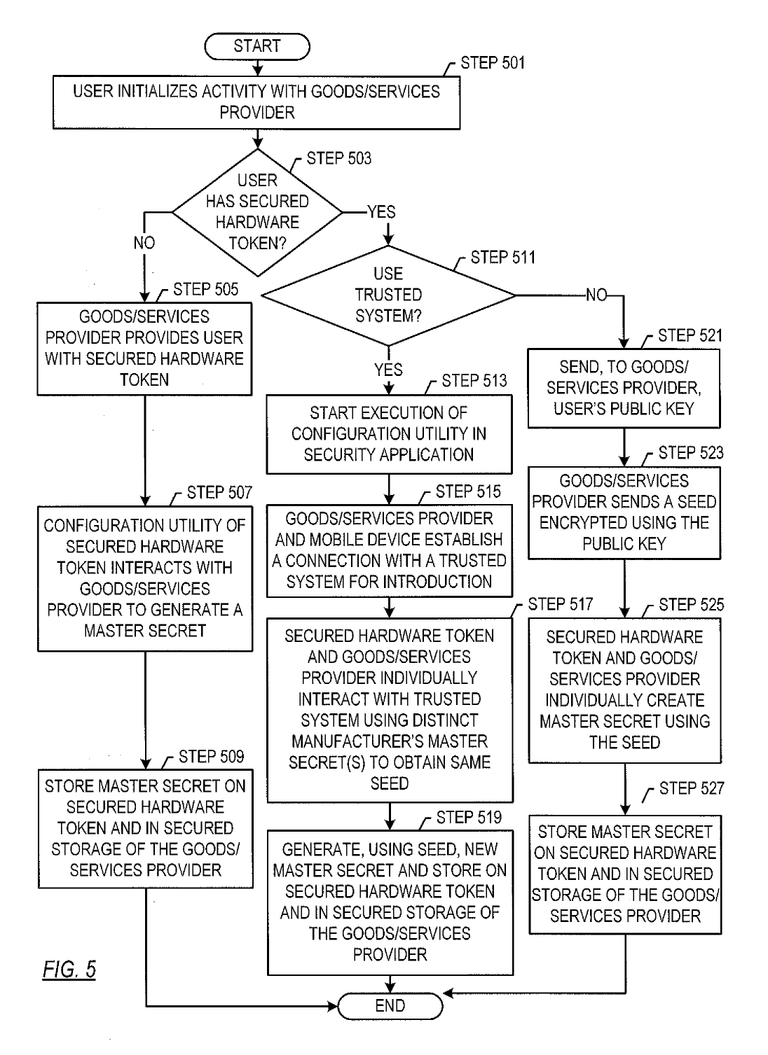

FIGS. 5-15 show flowcharts in one or more embodiments of the invention. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention. By way of an example, determination steps may not require a processor to process an instruction unless an interrupt is received to signify that a condition exists in accordance with one or more embodiments of the invention. As another example, determination steps may be performed by performing a test, such as checking a data value to test whether the value is consistent or not consistent with the tested condition in accordance with one or more embodiments of the invention. Many different types of software statements or hardware circuits may be used to perform the various steps of FIGS. 5-15. The different equivalent statements or circuits that achieve same or similar results are included within the scope of the invention.

FIG. 5 shows a flowchart for initializing a secured hardware token for a user in one or more embodiments of the invention. In Step 501, a user initializes activity with a goods/services provider in one or more embodiments of the invention. For example, the user may contact the goods/services provider in person, via a website, via telephone, or any other mode of contact. The user may initiate the contact or expressly or impliedly agree to a contact that is initiated by another. While communicating with the goods/services provider, the user may request or agree to communicate with the goods/services provider using a secured hardware token. For example, as part of initializing a new account with the user, in order to increase security, the goods/services provider may offer the user to use a master secret on a secured hardware token for communications and authentication.

In Step 503, a determination is made whether the user has a secured hardware token in one or more embodiments of the invention. For example, the user may already have a secured hardware token provided by the trusted system or another goods/services provider.

In Step 505, if the user does not have a secured hardware token, then the goods/services provider may provide the user with the secured hardware token. For example, if the user is communicating in person with the goods/services provider, such as through a representative, the goods/services provider may personally hand a secured hardware token to the user. Specifically, the goods/services provider may have a set of secured hardware tokens that are not yet configured for any users. Each of the secured hardware tokens may be created by the trusted system, the goods/services provider, or another third party. As another example, the goods/services provider may order a new secured hardware token from the trusted system, another goods/services provider, another third party, or an entity related to the goods/services provider.

In Step 507, the configuration utility of the secured hardware token interacts with the goods/services provider to generate a master secret. For example, if a kiosk is available, the user may insert the secured hardware token into the kiosk to configure the secured hardware token. The kiosk may be any device with a hardware port for the secured hardware token that has a secured, and optionally, a direct, connection to the goods/services provider. As another example, the configuration utility may interact through the user's mobile device to configure the secured hardware token. The interaction between the configuration utility and the goods/services provider may be to create an agreed upon seed or an agreed upon master secret. If a seed is used, the seed may be any password, passphrase, or series of characters. For example, the seed may be “the cow jumped over the moon,” “#8$#DsaVA(@12w@,” or any other collection of characters (e.g., symbols and/or alphanumeric characters).

In some embodiments of the invention, user input is used to generate the seed. For example, a user may submit at least a portion of the seed by entering a string of characters to the configuration utility. The goods/services provider may submit another portion of the seed. In alternative embodiments, the seed and/or master secret is created without user input. For example, the goods/services provider and/or configuration utility may provide a string of random characters to the configuration utility or goods/services provider.

If a seed is used, the configuration utility on the secured hardware token may input the seed into the n-bit generator to generate a new n-bit result. Additionally, the goods/services provider may independently generate the same new n-bit result using its own copy of the n-bit generator and the seed. The new n-bit result is a new master secret.

In Step 509, the master secret is stored on the secured hardware token and in secured storage of the goods/services provider. Specifically, the master secret is associated with an identifier in the secured persistent storage on the secured hardware token. Further, the master secret may be stored with a length for n-bit result(s) generated using the master secret. In one or more embodiments of the invention, the goods/services provider provides the configuration utility with the identifier and the length to store with the master secret.

Although not shown in FIG. 5, Steps 507 and 509 may be performed before Step 505. Specifically, the user may be provided with a preconfigured secured hardware token that already has one or more master secrets. In such a scenario, the goods/services provider only associates the secured hardware token with the user in its storage.

Returning to Step 503, if the user has a secured hardware token, then the secured hardware token may need to be configured for communications with the goods/services provider. In Step 511, a determination is made whether to use the trusted system (e.g., trusted system of FIG. 1) to configure the secured hardware token. For example, the user and the goods/services provider may agree to use the trusted system. As another example, the goods/services provider may instruct the user to use the trusted system. As another example, the user may initialize communication with the goods/services provider through the trusted system.

In Step 513 of FIG. 5, if the trusted system is to be used, execution of the configuration utility in the security application of the secured hardware token is started in one or more embodiments of the invention. For example, the user may access an application on the mobile device that is the configuration utility or connected to the configuration utility.

In Step 515, the goods/services provider and the mobile device establish a connection with a trusted system for an introduction in one or more embodiments of the invention. Both the goods/services provider and the mobile device create secured communication channels with the trusted system, each using separate and distinct master secrets. Specifically, the secured hardware token is already configured to communicate with the trusted system using the manufacturer's master secret defined for the secured hardware token in one or more embodiments of the invention. Thus, a communication channel is established whereby the user is authenticated and communications are encrypted with the user using the manufacturer's master secret. Similar steps may be performed for the goods/services provider to establish the secured communication channel with the trusted system. In the connection, the goods/services provider may request the generation of the master secret for communication with the user. Similarly, the user and/or mobile device may request the generation of the same master secret for communication with the goods/services provider.

In Step 517, the secured hardware token and the goods/services provider individually interact with the trusted system using distinct master secrets to obtain the same seed in one or more embodiments of the invention. Using the secured communication channels, the trusted system sends the same seed to both the user and the goods/services provider.

In Step 519, a new master secret is generated and stored on the secured hardware token and in secured storage of the goods/services provider in one or more embodiments of the invention. Generating the master secret using the seed and storing the master secret may be performed in a manner that is the same or similar to the manner discussed above with respect to Steps 507 and 509.

Although not shown in FIGS. 5-15, in one or more embodiments of the invention, before any master secret is stored on the secured hardware token during a remote configuration, both the goods/services provider and secured hardware token test and verify that each independently created identical master secrets. Verifying the master secret may be performed, for example, by the mobile device or the secured hardware token sending a challenge to the goods/services provider. The goods/services provider then uses the challenge and, the newly created master secret to generate an n-bit result to send to the secured hardware token via the mobile device. The secured hardware token may verify that the n-bit result received from the goods/services provider matches a similarly generated n-bit result that is generated by the secured hardware token. If the two n-bit results match, then the new master secret is stored. If the two n-bit results do not match, then the master secret is not stored in one or more embodiments of the invention. Alternately, the goods/services provider could issue the challenge or both end-points (e.g., mobile device and goods/services provider) could issue challenges. In the event both end-points issue a challenge, then the n-bit result would be portioned with each end-point verifying the result of the other end point.

Returning to Step 511 of FIG. 5, if a determination is made not to use the trusted system, then the flow may proceed to using the public key infrastructure. In Step 521, the user's public key is sent to the goods/services provider. For example, the user's mobile device may send the user's public key to the goods/services provider. As another example, the goods/services provider may obtain the public key from a trusted registrar of public keys.

In one or more embodiments of the invention, the user's public key is a public key of the user's secured hardware token and the user's private key may be stored on the secured hardware token. For example, an identifier of the secured hardware token may have a corresponding public key. In such a scenario, the mobile device may send to the goods/services provider in Step 521, the identifier of the secured hardware token. The goods/services provider may obtain the user's public key, for example, from a trusted public key registry.

In Step 523, the goods/services provider sends a seed encrypted by using the public key in one or more embodiments of the invention. When the mobile device receives the seed, the mobile device or the secured hardware token decrypts the seed using the user's private key.

Although not shown in FIG. 5, rather than the goods/services provider obtaining the user's public key and sending an encrypted seed, the user may obtain the goods/services provider public key and send an encrypted seed to the goods/services provider. For example, an application executing on the user's mobile device or the configuration utility may perform the steps to provide the goods/services provider with the seed.

Although not shown in FIG. 5, in addition to the goods/services provider obtaining the user's public key and sending the encrypted seed, the user may obtain the goods/services provider public key and send the encrypted seed to the goods/services provider. In such a scenario, the seed from the goods/services provider and the seed generated by the mobile device/user may be concatenated together and used as a single seed. The single seed may be used by the goods/services provider and the mobile device to independently generate the master secret. Rather than concatenating the seeds together, the seeds may be used separately as inputs to the n-bit generator. The n-bit generator may combine the seeds, such as by using the bit shuffler in one or more embodiments of the invention.

In Step 525, the secured hardware token and the goods/services provider independently create the master secret using the seed in one or more embodiments of the invention. In Step 527, the master secret is stored on the secured hardware token and in secured storage of the goods/services provider in one or more embodiments of the invention. Generating the master secret using the seed and storing the master secret may be performed in the same or similar to the manner discussed above with respect to Steps 507 and 509.

Although not shown in FIG. 5, the goods/services provider may provide the user with an application that uses the master secret. For example, the goods/services provider may directly provide the application, such as by configuring the user's mobile device, giving the user a computer readable storage medium that has the application, or performing another function. As another example, the goods/services provider may give the user instructions to obtain the application. Accordingly, the application is installed on the user's mobile device. In one or more embodiments of the invention, the application is installed on the user's device prior to the user configuring the secured hardware token with the master secret for the goods/services provider. Specifically, the application may include functionality to, when executed by the mobile device, initiate configuration of the secured hardware token.

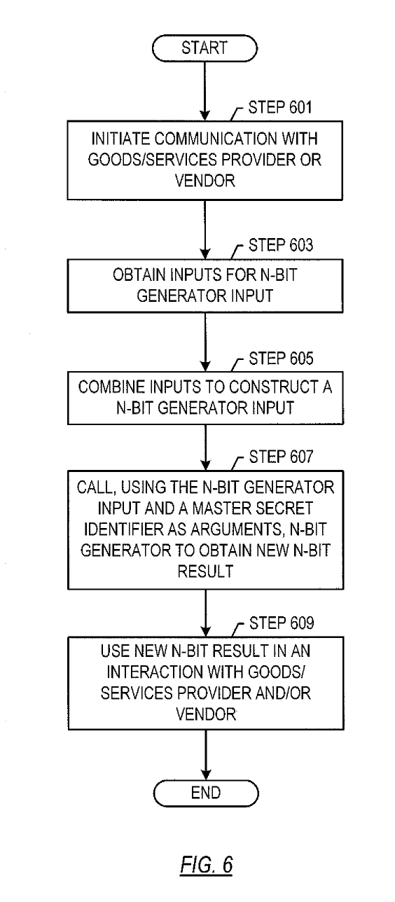

Turning to FIG. 6, FIG. 6 shows a flowchart for using the master secret in one or more embodiments of the invention. In one or more embodiments of the invention, the steps of FIG. 6 are performed by an application executing on the mobile device. In alternative embodiments of the invention, some or all of the steps may be performed by a different entity or component. In Step 601, a communication is initiated with the goods/services provider or a vendor. For example, a user may start the application on the mobile device. The application may start communicating with the goods/services provider or a vendor. As another example, the application may receive a connection request from the goods/services provider or vendor or may be preconfigured to communicate with the goods/services provider or vendor at a predefined time. In other embodiments of the invention, the application only starts communicating with the goods/services provider or vendor after some or all of the other steps of FIG. 6 are performed.

In Step 603, inputs for the n-bit generator input are obtained in one or more embodiments of the invention. In one or more embodiments of the invention, the inputs that are obtained are dependent on the use and the application. For example, some inputs, such as a pass code, may be obtained by presenting the user with a text box to solicit user's input and then parsing the user's input. Other inputs, such as transaction related inputs, may be obtained from the goods/services provider or vendor. For example, the input may be obtained while in a communication session with the vendor or goods/services provider. Other inputs, such as document metadata, may be extracted from stored data. In one or more embodiments of the invention, the application executing on the mobile device includes instructions that obtain the input in accordance with the type of input and the application.

In Step 605, the inputs are combined to construct the n-bit generator input in one or more embodiments of the invention. In one or more embodiments of the invention, the application concatenates the inputs into a single sequence of bits or characters. In the process of combining the inputs, the application may add additional characters so that fields are fixed length, identify and include the size of each field into the n-bit generator input, identify and include the size of the n-bit generator input in the n-bit generator input, add field breaks, and/or perform other actions to generate the n-bit generator input in accordance with the application.

In Step 607, the n-bit generator is called using the n-bit generator input and master secret identifier as arguments to obtain a new n-bit result. Specifically, the application issues a call to the secured hardware token. The call includes, as arguments, the master secret identifier and the n-bit generator input. The application may be preconfigured to use a particular master secret identifier for the particular use of the n-bit result. At this stage, the call is passed to the n-bit generator on the secured hardware token. The n-bit generator may perform steps, such as those described in FIG. 7, to generate the n-bit result. The n-bit generator may respond to the application with the n-bit result. Thus, in one or more embodiments of the invention, the steps performed by the n-bit generator and the master secret are not exposed outside of the secured hardware token, thereby minimizing the possibility of a security breach. Further, because different n-bit results are used for different operations, a nefarious user who obtains an n-bit result could, at worst, only violate the security of the single operation. In other words, a nefarious user would require access to the internal operations of the secured hardware token and mobile device to violate the security of more operations in one or more embodiments of the invention.

In Step 609, the n-bit result is used in an interaction with the goods/services provider and the vendor. The use of the n-bit result is based on the reason for the interaction with the goods/services provider and vendor. For example, the n-bit result may be used to authenticate the user, as a symmetric encryption solution for encrypting communications, to confirm that a transaction purporting to be from the user is in fact from the user, and/or to provide a verification code for later validating the user or transaction. Each application may have different mechanisms for using the n-bit result. For example, one application may use the n-bit result as an encryption solution by partitioning the n-bit result into two separate bit strings. Partitioning the n-bit result is to divide the n-bit result into individual bit strings. Partitioning the n-bit result may include parsing the n-bit result. For example, the first k bits of the n-bit result may specify the number of bits in an encryption key (e.g., m bits). The second m bits may be used as an encryption key while the third string of bits may be used to select the encryption algorithm. Another application may append the n-bit result to the n-bit generator input in order for the goods/services provider to confirm that the user validated the operation.

FIG. 7 shows a flowchart for the n-bit generator to generate the n-bit result in one or more embodiments of the invention. In Step 701, the n-bit generator receives, from an application, a call for a new n-bit result with an n-bit generator input and an identifier of a master secret in one or more embodiments of the invention.

Although not shown in FIG. 7, the n-bit generator may authenticate the user, for example, by presenting a challenge to the user, receiving a pass code in response to the challenge, and confirming that the received pass code is equal to a stored pass code. If the received pass code is equal to the stored pass code, the n-bit generator may proceed with the steps of FIG. 7. If the received pass code is not equal to the stored pass code, the n-bit generator may transmit an error message and not take further action, and, thereby, present the user another opportunity to enter the correct pass code, or perform other Steps. For example, if the mobile device is a smart phone, the smart phone may be configured to contact the police and enable the global positioning system (GPS) tracking on a threshold number of failed attempts at providing the correct pass code. By way of another example, if the mobile device is a smart phone, the phone may send a text message to a national security center as part of a service for fee program. The national security center may then attempt to call the user to verify that the user has their mobile device. The aforementioned steps may proceed the same as or similar to a home alarm going off and the call center calling the homeowner prior to sending emergency services personnel to the address.

In Step 703, the n-bit generator obtains, from secured persistent storage, the master secret referenced by the master secret identifier. For example, the n-bit generator may perform a lookup in the secured persistent storage to identify the master secret that is uniquely associated with (e.g., in a one to one correspondence) with the master secret identifier. In one or more embodiments of the invention, the n-bit generator may similarly identify the length for the n-bit result corresponding to the master secret from the secured persistent storage.

In Step 705, the n-bit generator generates a message digest using the master secret and the n-bit generator input as inputs for the n-bit generator. For example, the n-bit generator may perform a bit-shuffle to combine the master secret with the n-bit generator input and, thereafter, perform a hash function on the result to generate the message digest.

In Step 707, a determination is made whether to generate another message digest in one or more embodiments of the invention. Determining whether to generate another message digest is in accordance with the length of the n-bit result specific to the application. In one or more embodiments of the invention, the determination may be performed using a counter. Specifically, based on the call being received in Step 701, the length of the n-bit result corresponding to the master secret identifier may be stored in the counter. Upon each iteration of the n-bit generator to create a message digest, the counter is decremented. When the counter is greater than zero, then the determination is made to create a new message digest. When the counter is less than or equal to zero, then the determination may be made not to create a new message digest.

In Step 709, if a determination is made to create another message digest, then a change value and other components are extracted from the message digest. The other components that are extracted may include, for example, a portion of the n-bit result. For example, the change value may be the first 128 bits of the message digest and the portion of the n-bit result may be the remaining bits. The change value is a set of bits that, because it is a different input, assists in the creation of a different message digest.

In Step 711, the change value is combined with the master secret to create an interim secret. Combining the change value with the master secret may be performed, for example, by a bit shuffler. Specifically, any of the operations discussed above with respect to the bit shuffler may be performed to combine the change value with the master secret.

In Step 713, a message digest is generated using the interim secret and the master secret as inputs to the n-bit generator. Step 713 may be performed, for example, the same or similar to the manner discussed above with reference to Step 705. In one or more embodiments of the invention, rather than performing Step 711 to create an interim secret and then performing Step 713 to generate another message digest using the interim secret, the next sequential message digest may be generated using the change value and the master secret as inputs into the n-bit generator.

Continuing with FIG. 7, from Step 713 the logic flow continues with Step 707, where a determination is made whether to generate another message digest in accordance with one or more embodiments of the invention. In Step 707, if a determination is made to create an additional message digest, then the steps repeat starting with Step 709.

Alternatively, if a determination is made not to create another message digest, then in Step 715, the n-bit result is constructed using the message digest(s). For example, if multiple message digests are created, all or a portion of the message digests may be concatenated together to create the n-bit result. In Step 717, the n-bit result is returned to the application.

Additionally, although not shown in FIG. 7, a message digest or a portion thereof may be used to generate a master secret. For example, a change value may be extracted from at least one of the message digests. The n-bit generator may use the change value and the master secret to generate a new message digest. The new message digest may be stored in the secured persistent storage as a new master secret. Thus, the master secret may be dynamic by changing over time, such as with each use of the master secret. In one or more embodiments of the invention, prior to storing a dynamic master secret, the master secret is verified. A dynamic master secret may be used to establish an additional level of security, such as to access a tangible item. In one or more embodiments of the invention, verifying the dynamic master secret may be performed by using the prior n-bit result that is communicated between the application and the security interface as a change value to create the dynamic master secret.

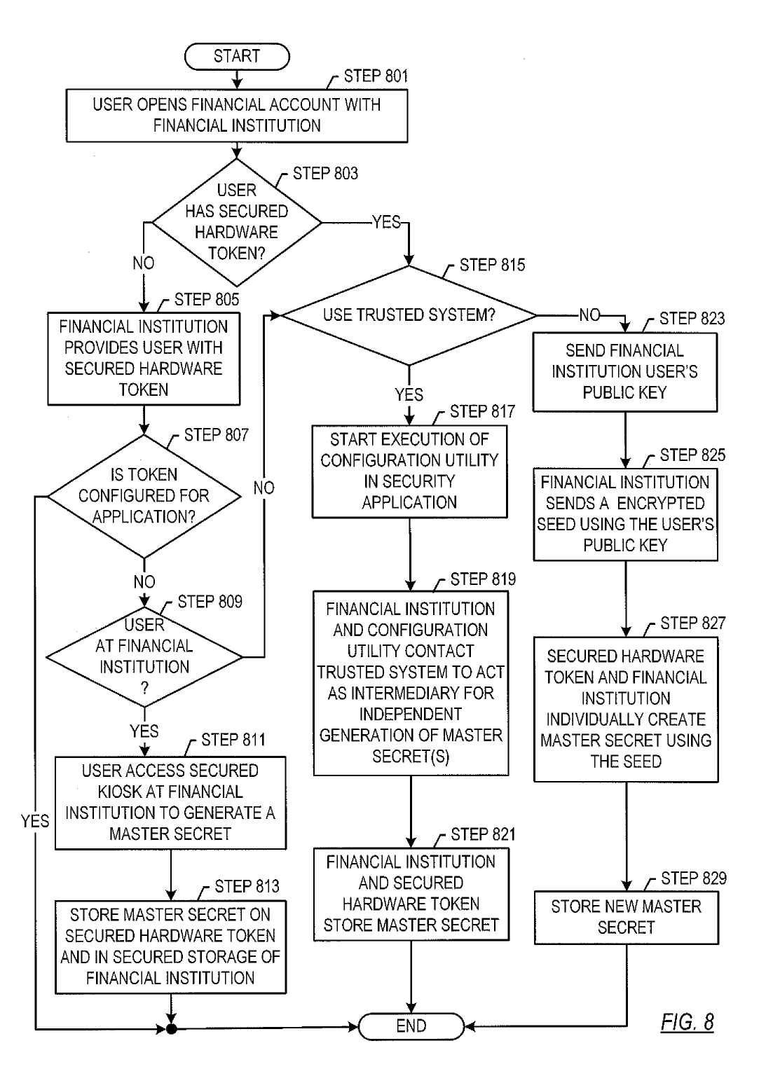

FIG. 8 shows a flowchart for configuring a secured hardware token when the goods/services provider is a financial institution. For example, the financial institution may be a bank, a credit card company, an investment services company, or another type of institution or business entity that has financial accounts for users.

In Step 801, the user opens a financial account with the financial institution. For example, the user may open the financial account in person, such as at a branch office, over the phone, or via the Internet.

In Step 803, a determination is made whether the user has a secured hardware token. For example, a financial institution representative, the financial institution's website, etc. may ask the user if the user has a secured hardware token.

If the user does not have a secured hardware token, then in Step 805, the financial institution may provide the user with the secured hardware token. For example, a representative may give the user a secured hardware token that the representative has in inventory for new account holders. As another example, a new secured hardware token may be ordered for the user, such as from a manufacturer of the secured hardware token, from a business center of the financial institution, from a distributor, or from another entity. The ordering of the secured hardware token may be performed by the financial institution or initiated by the financial institution's website in one or more embodiments of the invention.

In Step 807, a determination is made whether the token is configured. For example, the token may be preconfigured with master secret(s) when the user receives the token. In other words, the master secret(s), master secret identifier(s), and length(s) may be already stored on the token. If the master secret is not associated with the user's financial account, then the financial institution may obtain a token identifier from the token and associate the secured hardware token with the financial account. When the user receives the secured hardware token, the user may be required to activate the master secret, such as by using general activation mechanisms, in one or more embodiments of the invention. If the token is configured, then the user may begin to use the token once it is activated and associated with the user's financial account.

If the secured hardware token is not preconfigured, then configuration of the secured hardware token may commence. In Step 809, a determination is made whether the user is located at the financial institution. If the user is located at the financial institution, then the user may access a secured kiosk at the financial institution to generate a master secret in Step 811. For example, the user or a representative may insert the secured hardware token in a physical direct port of the kiosk. In one or more embodiments of the invention, at this stage, the kiosk is directly physically connected to the secured hardware token rather than wirelessly connected.

Further, the user may submit an authentication code, such as a PIN or a pass code, to the kiosk for the kiosk to validate the user. The kiosk may, with or without user input of at least a portion of the seed, submit a seed to the configuration utility of the secured hardware token. In such a scenario, the financial institution and the secured hardware token may independently generate the same master secret using the seed. Alternatively, the kiosk may generate the master secret and store the master secret in the secured persistent storage of the secured hardware token. Because of the direct and physical connection, communication between the secured hardware token and the kiosk may be assumed to be secure.

In Step 813, the master secret is stored in secured persistent storage on the secured hardware token and in secured storage of the financial institution. Specifically, at this stage, both the secured hardware token and the financial institution have a copy of the master secret.

Continuing with FIG. 8, in Step 809, if the user is not at the financial institution or already has a secured hardware token, the user may use a trusted system to configure the secured hardware token. A determination is made in Step 815 whether to use a trusted system to configure the secured hardware token.

If a determination is made to use the trusted system, then in Step 817, execution of the configuration utility of the security application is started. Starting execution of the configuration utility may be performed in the same or similar to the manner discussed above with regards to Step 513 in FIG. 5

Continuing with FIG. 8, in Step 819, the financial institution and the configuration utility contact the trusted system to act as an intermediary for independent generation of master secret(s). In Step 821, the financial institution and the secured hardware token store the master secret(s). Steps 819 and 821 may be performed in the same or similar to the manner discussed above with respect to Steps 515, 517, and 519 of FIG. 5. Further, as discussed above and in FIG. 5, the newly created master secret may be tested and verified prior to storage.

Returning to Step 815 of FIG. 8, if a determination is made not to use the trusted system, then a determination may be made to use the public key infrastructure. In Step 823, the user's public key is sent to the financial institution. For example, the user's mobile device may send the user's public key to the financial institution. As another example, the financial institution may obtain the user's public key from a trusted registrar of public keys.

In one or more embodiments of the invention, the user's public key is a public key of the user's secured hardware token and the user's private key may be stored on the secured hardware token. For example, an identifier of the secured hardware token may have a corresponding public key. In such a scenario, the mobile device may send to the financial institution in Step 823, the identifier of the secured hardware token. The financial institution may obtain the public key, for example, from a trusted public key registry.

In Step 825, the financial institution sends a seed encrypted using the user's public key in one or more embodiments of the invention. When the mobile device receives the seed, the mobile device or the secured hardware token decrypts the seed using the private key.

Although not shown in FIG. 8, rather than the financial institution obtaining the user's public key and sending the encrypted seed, the user may obtain the financial institution's public key and send the encrypted seed to the financial institution. For example, an application executing on the user's mobile device or the configuration utility may perform the steps to provide the financial institution with the seed.

Although not shown in FIG. 8, in addition to the financial institution obtaining the user's public key and sending an encrypted seed, the user may obtain the financial institution's public key and send an encrypted seed to the financial institution. In such a scenario, the seed from the financial institution and the seed generated by the mobile device/user may be concatenated together and used as a single seed. The single seed may be used by the financial institution and the mobile device to independently generate the master secret. Rather than concatenating the seeds together, the seeds may be used separately as inputs to the n-bit generator. The n-bit generator may combine the seeds, such as by using the bit-shuffler in one or more embodiments of the invention.

In Step 827, the secured hardware token and the financial institution individually create the master secret using the seed in one or more embodiments of the invention. In Step 829, the master secret is stored in secured persistent storage on the secured hardware token and in secured storage of the financial institution in one or more embodiments of the invention. Generating the master secret using the seed and storing the master secret may be performed the same or similar to the manner discussed above with respect to Steps 507 and 509 in FIG. 5.

Although not shown in FIG. 8, the financial institution may provide the user with a financial application that uses the master secret. For example, the financial institution may directly provide the application, such as by configuring the user's mobile device, giving the user a computer readable storage medium that has the application, or performing another function. As another example, the financial institution may give the user instructions to obtain the application. For example, the financial institution may inform the user that the financial application is available on the online market of the user's mobile device or via the financial institution's website. Accordingly, the application is installed on the user's mobile device.

Although not shown in FIG. 8, if the user already has a secured hardware token when the user opens the financial account, the user may still use a kiosk to configure the secured hardware token for the financial account. Such use may be dependent, for example, on the security protocols and capabilities of the kiosk in one or more embodiments of the invention.

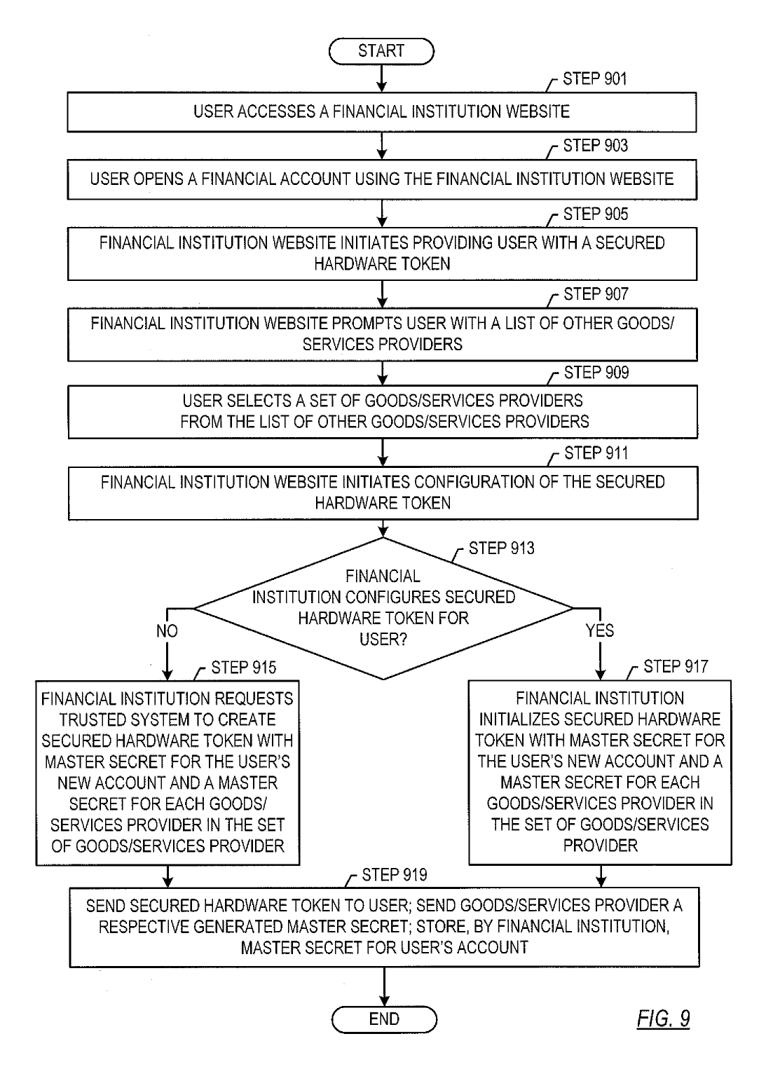

FIG. 9 shows another method for a user to have a secured hardware token in one or more embodiments of the invention. Specifically, FIG. 9 shows a flowchart to configure a secured hardware token for both a financial institution and for other goods/services providers. For example, while the user is creating the account, the financial institution may offer to the user products of partner goods/services providers. FIG. 9 shows a flowchart for configuring the secured hardware token with other goods/services provider master secrets in one or more embodiments of the invention.

In Step 901, the user accesses the financial institution website. For example, the user may have an existing account (e.g., a checking account) with the financial institution and want to create a new account (e.g., a savings account or a loan account). As another example, the user may not have any account or relationship with the financial institution and want to establish a new relationship with the financial institution.

In Step 903, the user opens a financial account using the financial institution's website in one or more embodiments of the invention. Specifically, the financial institution website may step the user through the opening of a new financial account. Although not shown in FIG. 9, the user may want to simply obtain a secured hardware token for the user's existing financial account. In such a scenario, Step 903 may be omitted.

In Step 905, the financial institution website initiates a process for providing the user with a secured hardware token. In Step 907, the financial institution website prompts the user with a list of other goods/services providers. The financial institution may present the list with a series of checkboxes or other user interface components. In one or more embodiments of the invention, in Step 909, the user selects a set of goods/services providers from the list of goods/services providers. The set of goods/services providers are goods/services providers that the user would like to conduct business with using the secured hardware token. For example, the financial institution may present the user with a list that includes an Internet goods seller, a movie rental service provider, a towing service, and other providers. Continuing with the example, the user may select the movie rental service provider and the towing service provider from the list. Accordingly, the new hardware token for the user is configured with master secrets for the financial institution, the movie rental service provider, and the towing service provider.

In Step 911, the financial institution website initiates configuration of the secured hardware token. For example, the financial institution website may issue a request to another server to order a new hardware token for the user. As another example, the financial institution website may issue an alert to an individual at the financial institution to order a new hardware token.

In Step 913, a determination is made whether the financial institution configures the secured hardware token for the user. If the financial institution does not configure the secured hardware token, then in Step 915 the financial institution requests the trusted system to create the secured hardware token with the master secret for the user's new account and for each goods/services provider in the set of goods/services providers that the user previously selected in Step 909. At this stage, the trusted system may independently perform the configuration. For example, the trusted system may select each seed and use the n-bit generator on the secured hardware token to generate each master secret. As another example, the trusted system may select a master secret and store the master secret in the secured persistent storage on the secured hardware token.

In Step 917, if the financial institution does configure the secured hardware token, then the financial institution initializes the secured hardware token with a master secret for the user's new account and for each goods/services provider in the set of goods/services providers that the user selected. In one or more embodiments of the invention, the financial institution may initialize the secured hardware token in a manner the same or similar to the trusted system initializing the secured hardware token in Step 915.

In Step 919, after the secured hardware token is initialized, the secured hardware token is sent to the user. Additionally, the financial institution stores the master secret for the user's account in secured storage of the financial institution. Further, the selected goods/services providers from the set of goods/services providers are sent the respective master secrets. Sending the goods/services providers the respective master secrets is performed using a secured communication channel.

Although FIG. 9 shows that the steps are performed via the financial institution website, the steps may be performed in person or via one or more intermediaries. For example, a representative of the financial institution may perform the steps of the financial institution website in FIG. 9 and personally hand the secured hardware token to the user. As another example, an intermediary, human or machine, may perform the steps of the financial institution website on behalf of the financial institution and provide the secured hardware token to the user.

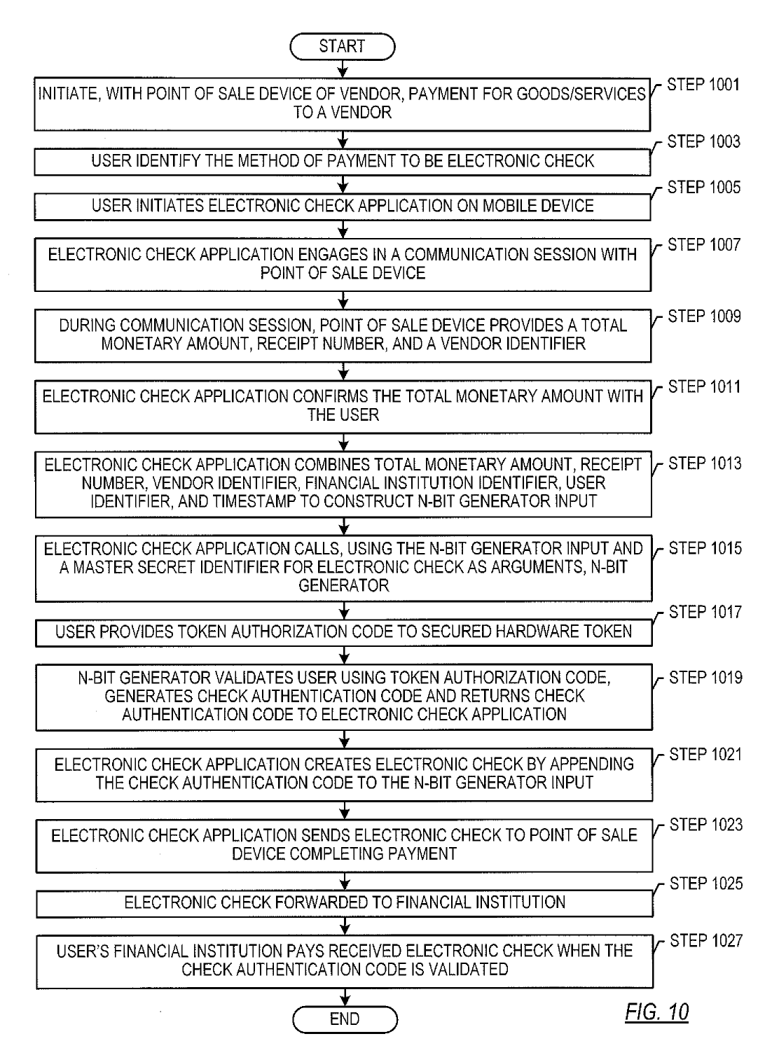

FIG. 10 shows a flowchart for a user to pay for goods and/or services using a mobile device and an electronic check in one or more embodiments of the invention. In Step 1001, payment for good/services to a vendor is initiated with a point of sale device. For example, the user may start the check out process with the point of sale device.

In Step 1003, the user identifies to the point of sale device that the method of payment is an electronic check. Because the electronic check method of payment is selected, the point of sale device may start the process to open a communication session with the mobile device.

In Step 1005, the user initiates the electronic check application on the mobile device. Specifically, the user may start the electronic check application and/or request that the electronic check application initiate payment using an electronic check.

In Step 1007, the electronic check application engages in a communication session with the point of sale device. At this stage, the electronic check application can receive and transmit data to the point of sale device.

In Step 1009, during the communication session, the point of sale device provides the total monetary amount, a receipt number, and a vendor identifier in one or more embodiments of the invention. The electronic check application confirms the total monetary amount with the user in Step 1011. For example, the electronic check application may display on the mobile device the total monetary amount, a receipt number, and a vendor identifier. The user may be required to select a software button, enter a pass code, or perform another action to confirm payment. Once the user confirms payment, the electronic check application may proceed to create the electronic check in one or more embodiments of the invention.

In Step 1013, the electronic check application combines the total monetary amount, the receipt number, the vendor identifier, financial institution identifier, user identifier, and a timestamp to construct the n-bit generator input. As discussed above, the total monetary amount, the receipt number, and the vendor identifier may be obtained from the point of sale device. The timestamp may also be similarly obtained from the point of sale device or may be obtained from a clock of the mobile device.

In one or more embodiments of the invention, the electronic check application may already have the financial institution identifier and the user identifier when the user initiates payment. For example, the electronic check application may be provided with such data during initial setup. Alternatively or additionally, the user may be required to submit the information or select a financial institution and/or user identifier from a preconfigured list when the user requests payment.

Combining the aforementioned information into the n-bit generator input may be performed in accordance with a predefined protocol with the financial institution. Specifically, the information is combined such that the financial institution can parse the n-bit generator input. In one or more embodiments of the invention, not only can the financial institution parse the n-bit generator input, but all entities (e.g., vendor, depository bank, etc.) that receive the electronic check may parse the n-bit generator input. Thus, the n-bit generator input may be defined in accordance with a standard protocol generally used by financial institutions for electronic checks.

In Step 1015, the electronic check application calls the n-bit generator using the n-bit generator input and the master secret identifier for the electronic check as arguments. The call is a request to the n-bit generator to generate a new n-bit result. The call may be in accordance with an application programming interface of the n-bit generator.

When the electronic check application calls the n-bit generator, the secured hardware token or a component thereof may require that the user is first authenticated. In such a scenario, the secured hardware token prompts the user to provide a token authorization code. The token authorization code may be the same code as the token activation code or the token authorization code may be different than the token activation code. In Step 1017, the user provides the token authorization code to the secured hardware token. The provided token authorization code may be a pass code, a biometric data, or another type of code. In Step 1019, the secured hardware token validates the token authorization code, and the n-bit generator generates a check authentication code, and returns the check authentication code to the electronic check application. Specifically, if the token authorization code provided by the user is valid, then the n-bit generator may proceed to produce an n-bit result, such as by performing the same or similar steps discussed above with reference to FIG. 7. The n-bit result is the check authentication code, and may serve as an electronic signature or approval.

In Step 1021, the electronic check application creates the electronic check by appending the check authentication code to the n-bit generator input in one or more embodiments of the invention. The electronic check application sends the electronic check to the point of sale device to complete payment in Step 1023.

In Step 1025, the electronic check is forwarded to the financial institution in one or more embodiments of the invention. In one or more embodiments of the invention, forwarding the electronic check to the financial institution may be performed via one or more intermediaries. For example, the vendor may deposit the electronic check in their account at a depository bank. The depository bank may credit the vendors account and transfer the electronic check directly or through an intermediary bank to the financial institution.

In Step 1027, the user's financial institution pays the received electronic check and debits the user's account when the check authentication code is validated. Validating the check authentication code may be performed, for example, by comparing the electronic check from the vendor with an electronic check sent directly to the financial institution from the mobile device. Another method for validating the electronic check is for the financial institution to generate a check authentication code by extracting the n-bit generator input from the electronic check, obtaining the master secret corresponding to the user from the secured storage of the financial institution, and calling the financial institution's copy of the n-bit generator with the master secret and the n-bit generator input. If the generated authentication code is equal to the received authentication code, then the financial institution confirms that the user authorized the electronic check.

Alternately, if the user's mobile device is a cell phone and can establish a connection with the user's financial institution, the mobile device can send a copy of the electronic check to the financial institution and when the vendor presents their copy of the electronic check the two copies can be compared. If the copies match, the electronic check is honored. Using near real time communications with the financial institution has the added benefit of keeping the user apprised of the current account balance. Thereby, the above steps may prevent an overdraft situation or alternately offer the user to use a preapproved line of credit to cover the purchase.

As shown, the use of the electronic check provides an easy mechanism for the user to perform a secured mode of payment. Further, because the electronic check is electronic and can be electronically verified, the financial institution may not spend as much money processing the electronic check as a physical paper check.

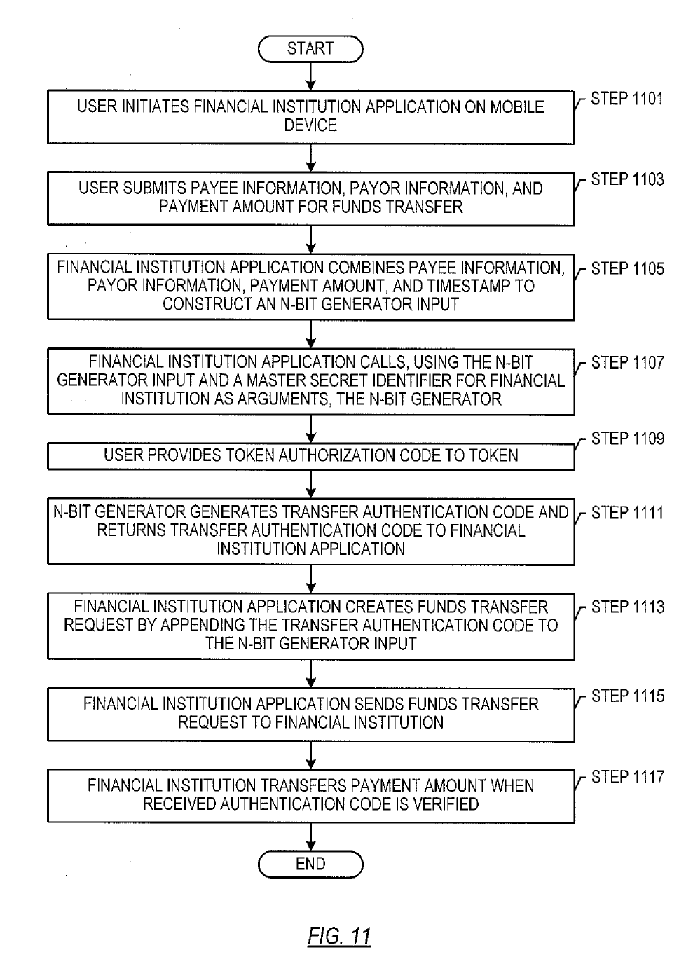

FIG. 11 shows a flowchart for performing funds transfer in one or more embodiments of the invention. In Step 1101, the user initiates the financial institution application on the mobile device. Specifically, the user may start the financial institution application and/or request a menu option/icon that allows the user to initiate a funds transfer.

In Step 1103, the user submits payee information, payor information, and payment amount for the funds transfer. The user may submit the information using the user interface components of the financial institution application on the mobile device.

In Step 1105, the financial institution application combines the payee information, the payor information, the payment amount, and a timestamp to construct the n-bit generator input. The timestamp may be obtained from a clock of the mobile device. Combining the aforementioned information into the n-bit generator input may be performed in accordance with a predefined protocol with the financial institution. Specifically, the information is combined such that the financial institution can parse the n-bit generator input.

In Step 1107, the financial institution application calls the n-bit generator using the n-bit generator input and the master secret identifier for the financial institution as arguments. The call is a request to the n-bit generator to generate an n-bit result. The call may be in accordance with an application programming interface of the n-bit generator.

When the financial institution application calls the n-bit generator, the secured hardware token or a component thereof may require that the user is first authenticated. In such a scenario, the secured hardware token prompts the user to provide a token authorization code. In Step 1109, the user provides the token authorization code to the secured hardware token. The provided token authorization code may be a pass code, a biometric data, or another type of code. If the token authorization code is successfully validated, the n-bit generator may proceed.

In Step 1111, the n-bit generator generates a transfer authentication code, and returns the transfer authentication code to the financial institution application. Specifically, the n-bit generator proceeds to produce an n-bit result, such as by performing the same or similar steps discussed above with reference to FIG. 7. The n-bit result is the transfer authentication code and may serve as an electronic signature or approval.

In Step 1113, the financial institution application creates the funds transfer request by appending the transfer authentication code to the n-bit generator input in one or more embodiments of the invention. The financial institution application sends the funds transfer request to the financial institution in Step 1115.

In Step 1117, the user's financial institution transfers the payment amount and debits the user's account when the received transfer authentication code is validated. Validating the funds transfer request may be performed by the financial institution generating a transfer authentication code by extracting the n-bit generator input from the funds transfer request, obtaining the master secret corresponding to the user from the secured storage of the financial institution, and calling financial institution's copy of the n-bit generator with the master secret and the n-bit generator input. If the generated authentication code is equal to the received authentication code, then the financial institution confirms that the user authorized the funds transfer. Accordingly, the financial institution completes the transfer.

Although not shown in FIG. 11, the funds transfer request may be through an electronic commerce application executing on the user's mobile device. Specifically, the user may initiate a purchasing of goods and/or services via the Internet and initiate a funds transfer using the electronic commerce application. In such a scenario, the electronic commerce application may perform the steps of FIG. 11 performed by the financial institution application. Alternatively, the electronic commerce application may request the payment transfer from the financial institution application.

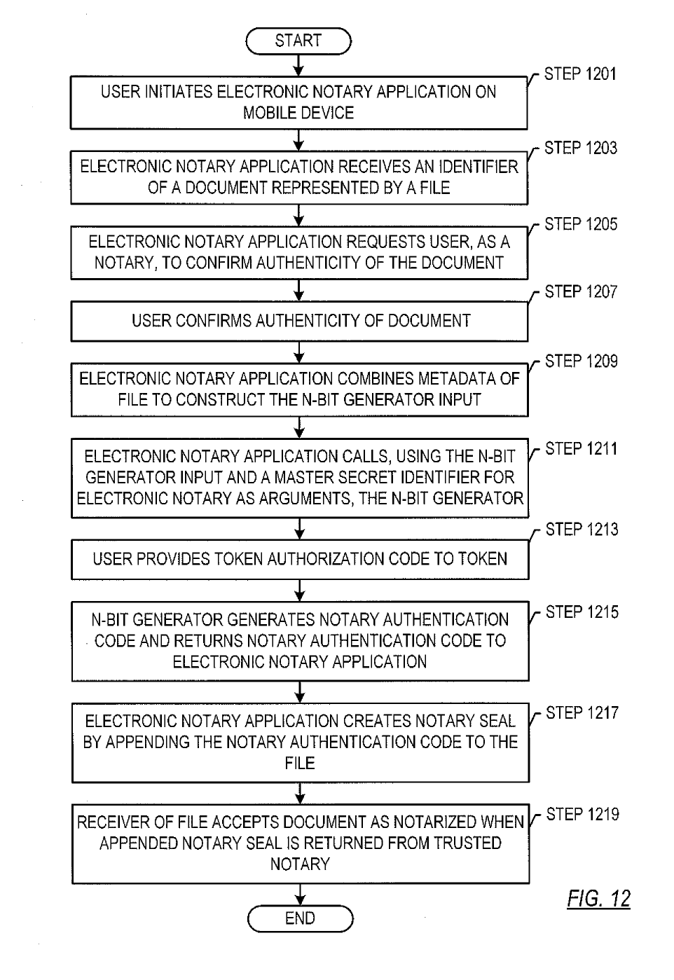

FIG. 12 shows a flowchart for an electronic notarization of a document in one or more embodiments of the invention. In one or more embodiments of the invention, the user in FIG. 12 may be a certified notary. In Step 1201, the user initiates the electronic notary application on the mobile device. Specifically, the user may start the electronic notary application and/or request a menu option that allows the user to initiate notarizing a document.

In Step 1203, the electronic notary application receives an identifier of a document represented by a file. Specifically, the user may submit a file name of the file to the electronic notary application. The user may submit the file name and/or any additional information using the user interface components of the electronic notary on the mobile device. Using the file name, the electronic notary application may obtain a copy of the document identified by the file name.

In Step 1205, the electronic notary application requests the user, as a notary, to confirm the authenticity of the document. For example, the electronic notary application may present the document to the user and request that the user verify the document. The user may verify the document, for example, by comparing the document with an original, confirming the identity of another person that provided the document, or perform other actions of a notary to confirm the authenticity of the document.

In step 1207, the user confirms the authenticity. For example, the user may select a user interface component or submit a pass code to assert that the document is authentic.

In Step 1209, the electronic notary application combines metadata of the file to construct an n-bit generator input. Specifically, the electronic notary application may extract information, such as a timestamp(s), file name, author, checksum, etc., from the metadata of the file having the document and combine the metadata into the n-bit generator input. In one or more embodiments of the invention, the checksum portion of the metadata is generated by the electronic notary application. By generating the checksum and incorporating the checksum into the notarized file n-bit generator input, the electronic notary application and/or the notary may use the checksum to later confirm that the file has not been modified.

In Step 1211, the electronic notary application calls the n-bit generator using the n-bit generator input and the master secret identifier for the electronic notary as arguments. The call is a request to the n-bit generator to generate a new n-bit result. The call may be in accordance with an application programming interface of the n-bit generator.

When the electronic notary application calls the n-bit generator, the secured hardware token or a component thereof may require that the user is first authenticated. In such a scenario, the secured hardware token prompts the user to provide a token authorization code. In Step 1213, the user provides the token authorization code to the secured hardware token. The provided token authorization code may be a pass code, a biometric data, or another type of code. If the token authorization code is successfully validated, the n-bit generator may proceed.

In Step 1215, the n-bit generator generates a notary authentication code, and returns the notary authentication code to the electronic notary application. Specifically, the n-bit generator proceeds to produce an n-bit result, such as by performing the same or similar steps discussed above with reference to FIG. 7. The n-bit result is the notary authentication code.

In Step 1217, the electronic notary application creates a notary seal by appending the notary authentication code to the file in one or more embodiments of the invention. At this stage, the document may be considered notarized. Specifically, the authenticity of the document can be verified by the notary seal. The notary seal is verifiable using the master secret or copy thereof.

In Step 1219, the receiver of the file accepts a document as notarized when an appended notary seal is returned from a trusted notary. The notary seal may be validated, for example, by the trusted system generating a notary authentication code by accessing an n-bit generator input from the document, obtaining the master secret corresponding to the notary from the secured storage of the trusted system, and calling electronic notary's copy of the n-bit generator with the master secret and the n-bit generator input. If the generated authentication code is equal to the authentication code appended to the document, then the notary notarized the document. Alternatively, a state certifying agency having the master secret may validate the notary. Further, in one or more embodiments of the invention, by having the checksum in the n-bit generator input, if the document changes, then the n-bit generator input changes resulting, with a high probability, in a different authentication code.

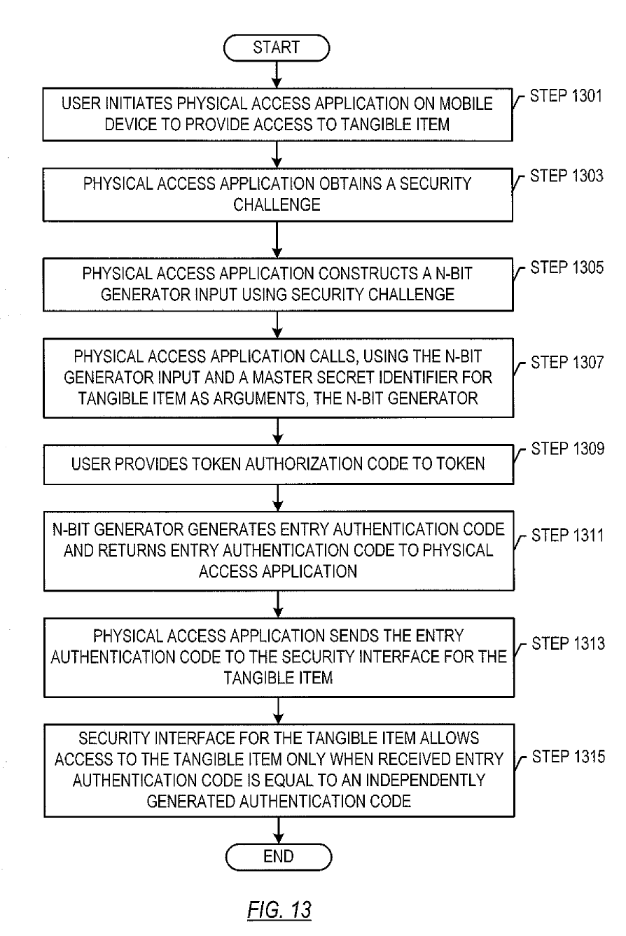

FIG. 13 shows a flowchart for a user to obtain physical access to a tangible item. For example, a user may want to start a car, unlock the car, unlock the user's house, enter a parking garage, enter a secured area of the user's workplace, turn off an alarm, access a safe, or otherwise access another tangible item. Using the steps of FIG. 13 for different tangible items allows the user to access each tangible item while only carrying a mobile phone. As discussed above, access to the tangible item is controlled by a security interface located at the tangible item. A physical access application executing on the mobile device communicates with the security interface to authenticate the user.

In Step 1301, the user initiates the physical access application executing on the mobile device to access a tangible item. Specifically, the user may start the physical access application and/or request a menu option and/or icon that allows the user to initiate accessing the tangible item. In one or more embodiments of the invention, the user may select the particular tangible item from a list of tangible items. If the security interface for the tangible item is in a low power mode, then the user may select a button on the security interface to initiate the transfer. The security interface may alternatively recognize that the mobile device is in close proximity to the security interface and automatically issue a challenge. If the security interface recognizes that the mobile device is in close proximity, Step 1301 may be omitted.

Although not shown in FIG. 13, the physical access application may initiate a communication session with a security interface for the tangible item. For example, the physical access application may initiate the communication session in response to Step 1301. Alternatively, the security interface may initiate the communication session. The security interface may be, for example, an electronic lock, a gate, or another interface.

In Step 1303, the physical access application obtains a security challenge in one or more embodiments of the invention. For example, the security challenge may be transmitted to the physical access application by the security interface associated with the tangible item. In one or more embodiments of the invention, the security challenge is a random string of characters generated by the security interface. The security challenge may change with each request to access the tangible item.

In Step 1305, the physical access application constructs an n-bit generator input using the security challenge. For example, the physical access application may use the security challenge directly as the n-bit generator input. Alternatively, the physical access application may combine the security challenge with other information, whereby the security interface also uses the same other information.

In Step 1307, the physical access application calls the n-bit generator using the n-bit generator input and the master secret identifier for the tangible item as arguments. In one or more embodiments of the invention, the master secret is specific to the tangible item. Thus, even though the same physical access application may be used for multiple different tangible items in one or more embodiments of the invention, the physical access application uses the master secret for the particular tangible item. The call is a request to the n-bit generator to generate a new n-bit result. The call may be in accordance with an application programming interface of the n-bit generator.

When the physical access application calls the n-bit generator, the secured hardware token or a component thereof may require that the user is first authenticated. In such a scenario, the secured hardware token prompts the user to provide a token authorization code. In Step 1309, the user provides the token authorization code to the secured hardware token. The provided token authorization code may be a pass code, a biometric data, or another type of code. If the token authorization code is successfully validated, the n-bit generator may proceed. Rather than or in addition to the token authorization code, the physical access application may present the user with a request for a pass code and may authenticate the user based on the pass code that the user submits.

In Step 1311, the n-bit generator generates an entry authentication code, and returns the entry authentication code to the physical access application. Specifically, the n-bit generator proceeds to produce an n-bit result, such as by performing the same or similar steps discussed above with respect to FIG. 7. The n-bit result is the entry authentication code.

In Step 1313, the physical access application sends the entry authentication code to the security interface for the tangible item. Sending the entry authentication code may be performed, for example, by using any type of network or direct data connection.

In Step 1315, the security interface for the tangible item allows access to the tangible item only when the received authentication code is equal to an independently generated authentication code. Specifically, the security interface may independently generate an authentication code by performing the same or similar steps as the physical access application and by using its own copy of the master secret, its own copy of the n-bit generator, and the security challenge that the security interface transmitted. In other words, the n-bit generator and the master secret, which are not provided by the security interface, must be correct for the security interface to allow access. If one of the aforementioned components is not correct, then the security interface may deny access. Although not shown in FIG. 13, the security interface may allow access when an override feature is used without departing from the scope of the invention. Such an external override feature may be a physical key or a command from a remote administrator who independently verifies the user or grants access to emergency personnel such as a police officer, fireman, or emergency medical services.

Although FIG. 13 shows the user providing a token authorization code, in one or more embodiments of the invention, the aforementioned step may be omitted. In such a scenario, the user may not be required to perform any steps in order to gain access to the tangible item. For example, the user may merely walk up to the tangible item with the mobile device and automatically gain access.

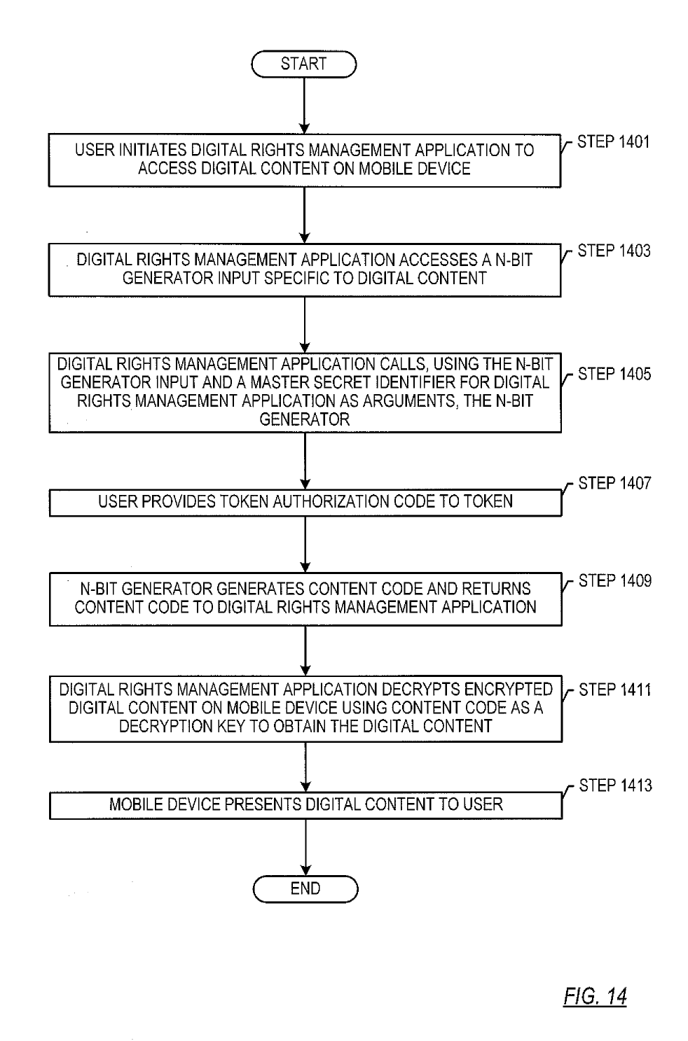

FIG. 14 shows a flowchart for accessing digital content in one or more embodiments of the invention. For the purposes of FIG. 14, consider the scenario where a user already has purchased digital content. For example, the user may purchase the digital content using the electronic check of FIG. 10 or the funds transfer request of FIG. 11.

In Step 1401, the user initiates the digital rights management application to access the digital content on the mobile device. For example, the user may select the digital content. In response to the selection, the digital rights management application may start performing the Steps of FIG. 14 to present the digital content to the user. In one or more embodiments of the invention, when the user requests access to the digital content, the digital content is encrypted using symmetric key encryption. The Steps of FIG. 14 may be performed to obtain the encryption key.

In Step 1403, the digital rights management application accesses an n-bit generator input specific to the digital content. In one or more embodiments of the invention, the n-bit generator input is created from the metadata of the digital content. Constructing the n-bit generator input may be performed the same or similar to the manner discussed above with respect to Step 1209 of FIG. 12. The n-bit generator input may be constructed by the digital content provider and transmitted to the digital rights management application; or, the n-bit generator input may be constructed by the digital rights management application.

In Step 1405, the digital rights management application calls the n-bit generator using the n-bit generator input and the master secret identifier for the digital rights management application as arguments. The call is a request to the n-bit generator to generate an n-bit result. The call may be in accordance with an application programming interface of the n-bit generator.

When the digital rights management application calls the n-bit generator, the secured hardware token or a component thereof may require that the user is first authenticated. In such a scenario, the secured hardware token prompts the user to provide a token authorization code. In Step 1407, the user provides the token authorization code to the secured hardware token. The provided token authorization code may be a pass code, a biometric data, or another type of code. If the token authorization code is successfully validated, the n-bit generator may proceed.

In Step 1409, the n-bit generator generates a content code, and returns the content code to the digital rights management application. Specifically, the n-bit generator proceeds to produce an n-bit result, such as by performing the same or similar steps discussed above with reference to FIG. 7. The n-bit result is the content code that is specific to the digital content.

In Step 1411, the digital rights management application decrypts the encrypted digital content on the mobile device using the content code as a decryption key to obtain the digital content. The mobile device presents the digital content to the user in Step 1413.

Although not presented above in FIG. 14, the following may exist and occur to provide the user with access to digital content. In one or more embodiments of the invention, the goods/services provider providing the digital content has a storage system connected to an encryption system. Access, from the Internet, to the storage system and the encryption system may be limited to only a gateway (e.g., a portal) through a firewall. An edge device may be interposed between the firewall and the Internet. The storage system may have unencrypted digital content. When a user requests digital content, such as in STEP 1401, the mobile device may request the digital content from the goods/services provider. The request may include an identifier of the user, the secured hardware token, or the mobile phone. The edge device may receive the request and transmit the request via the firewall to the encryption system.

The encryption system may use the identifier in the request to verify that the user has rights to access the digital content, such as by renting or purchasing the digital content or being a member of a group (e.g., a family) in which the digital content rented or purchased on the group's behalf If the digital content is rented, then the encryption system may verify that the user still has rights, such as by not exceeding the rental period or the number of views before providing access to the digital content. Further, the n-bit generator input may include an identifier of the rental period and the remaining number of views available for validation by the digital rights management application.

If the user has rights, the encryption system may obtain the master secret corresponding to the user and the secured hardware token. The encryption system may further obtain the digital content and encrypt the digital content using the master secret corresponding to the user. The encrypted digital content may then be sent to the user.

By encrypting the digital content when requested by the user, if the user is a member of a group, then each member of the group may obtain a copy of the encrypted digital content that is encrypted using their own master secret. By way of an example, consider the scenario in which Bob, as head of household, rents a movie. Bob may rent the movie for $3.00 and use the e-commerce application to pay for it. The Service Provider would have Bob's identifier, secured hardware token's serial number, and master secret stored on the encryption system. Associated with Bob's account may be a table or directory that includes all the content Bob has purchased and/or rented as well as the authorized persons who would have access to it.

Continuing with the example, consider the scenario in which Bob's family (i.e., Bob, Barbara, Jill and Jack) are approved to access content from Bob's account and Bob is the party designated to be financially responsible. Each family member has his or her own hardware token and unique master secret. Each family member may additionally have their own personal account and each can decide who is authorized to access their purchased/rented content.

Bob rents the movie that is good for 72 hours or 3 viewings and is set to expire when either occurs. In other words, if three members each viewed the movie then the movie cannot be viewed again. Further, if two family members watch the movie at one location, then two other members may watch in other locations concurrently or at different times. In addition, when the 72 hours has lapsed the content is removed from Bob's table or directory of authorized content.

The above method may be used by the goods/services provider to limit the number of viewings and track each viewing and decrement the count after each. Further, the encryption solution may be unique for each hardware token that accesses the content. Additionally, the encryption system may prevent young Jill from personally accessing movies, songs or content that has been designated inappropriate by Bob, the Dad.

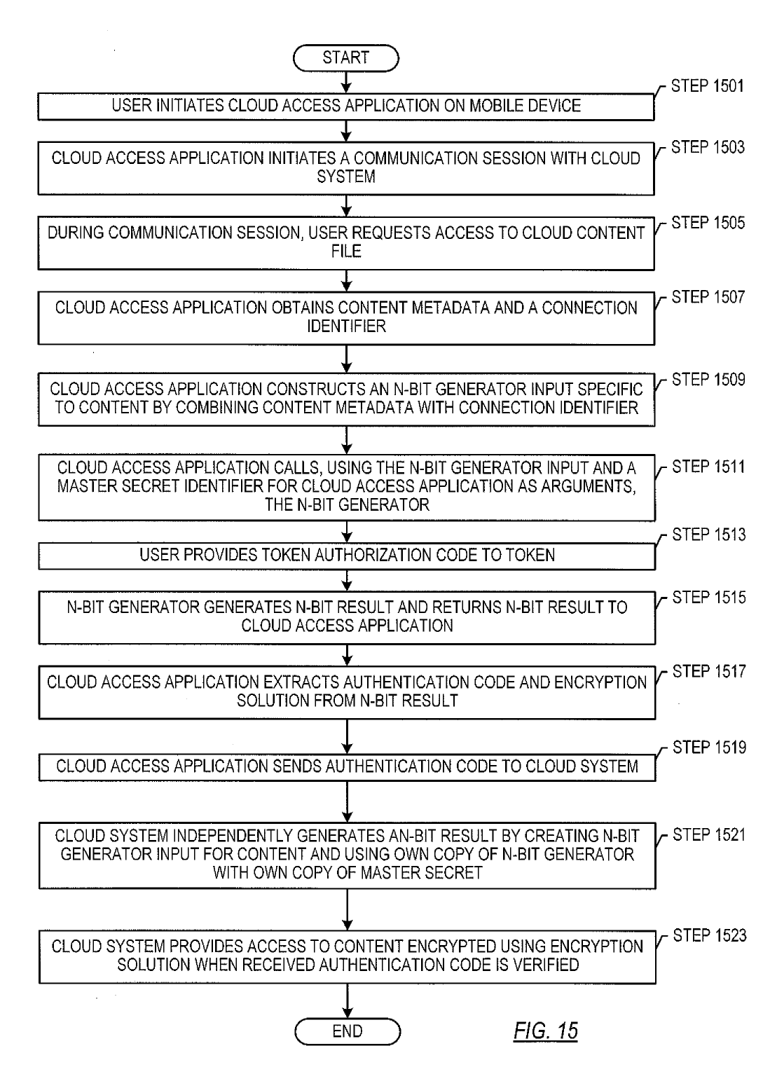

FIG. 15 shows a flowchart for a user to access secured data from a cloud server in one or more embodiments of the invention. In Step 1501, the user initiates the cloud access application to execute on the mobile device. In Step 1503, the cloud access application initiates a communication session with a cloud system. The cloud access application may be preconfigured with information to establish the communication session to the user's account. In one or more embodiments of the invention, during the communication session, the user requests access to a cloud content file in Step 1505. The cloud content file is any content stored remotely in the cloud system.

In Step 1507, the cloud access application obtains a connection/user identifier. Specifically, the cloud access application requests access to files from the cloud system. The cloud system may verify that the user is authorized to access the files. At this point, the cloud system would display a directory of files contained in the cloud system and which the identified user was authorized to access. The user might select the desired files from the directory; in much the same manner the user would navigate any file management system. Once the desired files are identified, the cloud system may proceed to provide the desired files.

In Step 1509, the cloud access application constructs an n-bit generator input specific to the content by combining the content metadata and the connection identifier. Creating the n-bit generator input may be performed the same or similar to the manner discussed above with respect to Step 1209 of FIG. 12.

In Step 1511, the cloud access application calls the n-bit generator using the n-bit generator input and the master secret identifier for the cloud access application as arguments. The call is a request to the n-bit generator to generate a new n-bit result. The call may be in accordance with an application programming interface of the n-bit generator.

When the cloud access application calls the n-bit generator, the secured hardware token or a component thereof may require that the user is first authenticated. In such a scenario, the secured hardware token prompts the user to provide a token authorization code. In Step 1513, the user provides the token authorization code to the secured hardware token. The provided token authorization code may be a pass code, a biometric data, or another type of code. If the token authorization code is successfully validated, the n-bit generator may proceed.

In Step 1515, the n-bit generator generates an n-bit result and returns the n-bit result to the cloud access application. Specifically, the n-bit generator proceeds to produce an n-bit result, such as by performing the same or similar steps discussed above with reference to FIG. 7. The n-bit result is specific to the content.

In Step 1517, the cloud access application extracts an authentication code and an encryption solution from the n-bit result. For example, the first portion of bits of the n-bit result may be an authentication code and the second portion may be an encryption solution. The encryption solution may include an encryption key and an algorithm selector. The algorithm selector may define which encryption algorithm to use.

In Step 1519, the cloud access application sends the authentication code to the cloud system. The cloud system independently generates an n-bit result by creating an n-bit generator input for the content and using its own copy of the n-bit generator with its own copy of the master secret in Step 1521. In other words, the cloud system may perform the steps similar to those discussed above with reference to FIG. 15 and FIG. 7 to generate the n-bit result and extract an authentication code and encryption solution.

In Step 1523, the cloud system provides access to the content encrypted using the encryption solution when the received authentication code is verified. In other words, when the received authentication code is equal to the authentication code generated in Step 1521, the cloud system transmits encrypted content to the cloud access application. The encrypted content is encrypted using the encryption key and a symmetric encryption algorithm. Thus, the cloud access application can decrypt the content using the same self-generated encryption key and symmetric encryption algorithm. The cloud access application may present the content to the user.

By way of an example and not a limitation, the following steps may be performed for a user to access files stored in the cloud system. The user requests access to his or her files stored in the cloud system. In response, the cloud system verifies the identity of the user and which files the user is authorized to access. For example, the authorized people may be the user, authorized medical professionals, or co-workers. If the user is authenticated, the cloud system presents the user with a directory of files. The user selects the desired files from the directory, such as in a same fashion that a user navigates a file management system. Continuing with the example, once the files are selected and assuming the user is authorized for the selected files, the cloud system constructs an n-bit generator input for each selected file using the metadata, a date/time stamp and optionally other information. The cloud system calls the n-bit generator and generates an n-bit result using the n-bit generator input and shared master secret. The n-bit result is used to encrypt each selected file, which is then moved into a download directory. The user downloads the files, which are encrypted, onto their local storage. Using the n-bit generator input attached to each file and the user's master secret the user recreates the n-bit result for each file and uses the n-bit result information to decrypt the file. After the user has reviewed the decrypted files and assuming the user does not want to make any changes to the files, the user erases the file from local storage. In the event the user is an authorized physician who has made changes to the file, the cloud access application may construct a new n-bit generator input and use the n-bit generator input and master secret to encrypt the modified file. The user then reconnects with the cloud system and proceeds thru the same series of steps; except that the cloud system is now accepting the upload of an encrypted file. After the file is uploaded, the cloud system regenerates the n-bit result and decrypts the file to be stored in the user's folders until the file is requested again.

Although not presented above in FIG. 15 and similar to FIG. 14, the following may exist and occur to provide the user with access to cloud content. In one or more embodiments of the invention, the cloud system providing the cloud content has a storage system connected to an encryption system. Access, from the Internet, to the storage system and the encryption system may be limited to only a gateway (e.g., portal) through a firewall. An edge device may be interposed between the firewall and the Internet. The storage system may have unencrypted cloud content for an owner. Specifically, the unencrypted cloud content may identify the owner of the content and anyone else that the owner authorizes to view the cloud content.

When a user requests cloud content, such as in STEP 1505, the mobile device may request the cloud content from the cloud system. The request may include an identifier of the user, the secured hardware token, or the mobile phone. The edge device may receive the request and transmit the request via the firewall to the encryption system.

The encryption system may use the identifier in the request to verify that the user has rights to access the cloud content (e.g., that the user is the owner or a person authorized by the owner). If the user has rights, the encryption system may obtain the master secret corresponding to the user and the secured hardware token. The encryption system may further obtain the cloud content and encrypt the cloud content using the master secret as described in FIG. 15. The encrypted content may then be sent to the user.

The steps of FIG. 15 may be performed for a variety of types of applications. For example, the user may want to access work documents while the user is out of the office. As another example, the cloud system may be a healthcare system that has the user's health history. In other words, a user may perform the steps of FIG. 15 when the user visits a doctor in order to obtain a copy of their health records that are stored on the cloud system. Further, the user may be the owner and authorize specific doctors, a practice, or emergency personnel access to all or a portion of the user's personal health history.

If the cloud system stores health records for the user, then the cloud system may provide a mechanism for emergency personnel to access the user's health records or a portion thereof. For example, consider the scenario in which the user is in an automobile accident. In such a scenario, the emergency personnel may use an emergency override to access the cloud content.

When the mobile device is a cell phone, the following steps may be performed. In an emergency, the cloud system may call the user's cell phone and if answered by emergency personnel requesting access to medical records, the EMS could enter a 4 or 5 key code to authenticate that the EMS has possession of the phone, such a code might be #66#. If the phone is damaged or not found the cloud system may work with the cell phone provider to determine if the user is or has recently been in the geographic location where emergency personnel says the user is injured and unresponsive. In other words, if the user's cell phone provider responds with the cell phone having not been tracked to a region that the emergency personnel claims the user is injured, then the cloud system may deny access in one or more embodiments of the invention. If, however, the user's cell phone provider has records where the user used the cell phone at Dulles airport and now emergency personnel claim the user is in a car accident in Alexandria, Va., the cloud system may grant access.

Alternatively, a key sequence entered on the mobile device could display the secured hardware token serial number. The emergency personnel may provide the secured hardware token serial number or other identifier to verify they possess the user's mobile device. In such a scenario, the cloud system may grant access to the personal health records of the user.

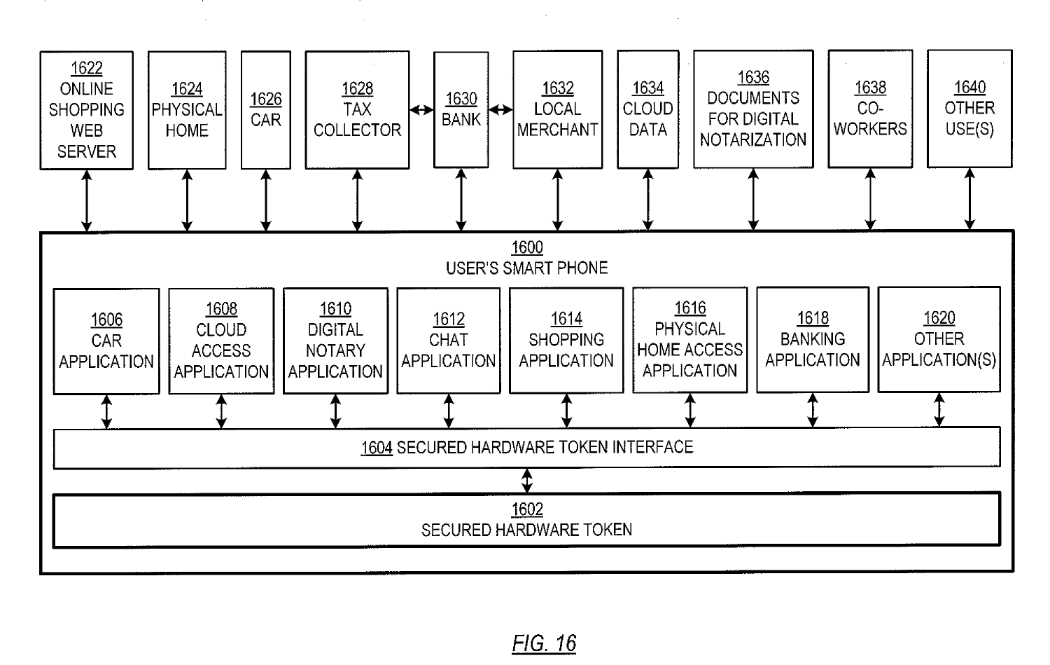

FIG. 16 shows an example in one or more embodiments of the invention. The following example is for explanatory purposes only and not intended to limit the scope of the invention. In the example, consider the scenario in which the user is Bob. Bob has a smart phone (1600). When Bob opened his account with Bank (1630), the Bank gave Bob a list of other products in which Bob might be interested. These products included an online shopping center (1622) and other products. Because Bob likes shopping, Bob decided to see the offerings available on the online shopping center (1622). Accordingly, Bob selects the additional products. The Bank (1630) sends Bob a secured hardware token (1602) with a master secret for Bob's account at the Bank (1630) and a separate master secret for each additional product (e.g., online shopping center (1622)) that Bob selected. Additionally, the Bank provides instructions to Bob on how to obtain the applications and sends the master secret for the shopping center to the shopping center. Bob downloads and installs the banking application (1618) and the shopping application (1614) on his smart phone (1600).

When Bob purchases his car and installs a security system in his home, he adds master secrets to access his physical home (1624) and his car (1626); and he downloads the car application (1606) and the physical home access application (1616). Bob also obtains a master secret for accessing the car and his house. Bob may similarly obtain a download of a cloud access application (1608) so that he may store data (1634) in the cloud, a digital notary application (1610) in order to notarize documents (1636), a chat application (1612) to communicate with co-workers (1638), and other applications (1620) for other uses (1640).

Each application interfaces with the secured hardware token (1602) using the secured hardware token interface (1604). Specifically, the secured hardware token (1602) stores a master secret for each application and can generate an n-bit result for each application. Thus, when Bob leaves his home, he only needs to bring his smart phone (1600).

For example, Bob can pay a local merchant (1632) using the banking application (1618) by performing the Steps of FIG. 10. Bob can pay his property taxes to the tax collector (1628) by using the banking application (1618) and performing the Steps of FIG. 11. Similarly Bob may purchase goods from the online shopping center (1622) using the shopping application (1614) and performing the Steps of FIG. 11. Bob may notarize documents (1636) using the digital notary application (1610) and performing the Steps of FIG. 12. When Bob wants to return home, performing the Steps of FIG. 13, Bob can use the car application (1606) to start his car (1626) and the physical home access application (1616) to unlock the door at his physical home (1624). As shown, the secured hardware token provides the user, such as Bob, the freedom to leave the house with only a smart phone while maintaining security in one or more embodiments of the invention.

A secured hardware token might be preloaded with an array of participating services and goods providers. For example, a national bank might wish to have their identifier and a master secret preloaded on every token bound for a specific geographic area. A well-known e-commerce website might wish to have their identity and a master secret preloaded on every secured hardware token manufactured. In one or more embodiments of the invention, all the preloaded master secrets would be specific to a token serial number. When the user initiates a request to conduct business with the vendor, the vendor could contact the trusted system and the trusted system would respond with the preloaded values. The secured hardware token manufacturer would thereby generate additional revenue by preloading values, thereby, streamlining the process of opening an account and engaging in commerce.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A secured hardware token for securing financial transactions comprising:
an embedded processor;
a secured persistent storage configured to store data, the data comprising:
an account master secret for an account at a financial institution, wherein the financial institution stores a copy of the account master secret in secured storage of the financial institution; and
a read only memory comprising a security application, which, when executed by the embedded processor, causes the embedded processor to:
receive, from a financial institution application executing on a mobile device, a first call for a first n-bit result, wherein the first call comprises a first n-bit generator input and a first master secret identifier;
obtain, from the secured persistent storage, the account master secret referenced by the first master secret identifier;
construct the first n-bit result specific to the first call using the account master secret and the first n-bit generator input as input to an n-bit generator in the security application; and
return the first n-bit result to the financial institution application, wherein the financial institution application provides the n-bit result to the financial institution,
wherein the financial institution is adapted to complete a financial transaction when the first n-bit result is verified.

2. The secured hardware token of claim 1, wherein the financial institution application is configured to:
create an electronic check by appending the n-bit result to the first n-bit generator input; and
send the electronic check to a point of sale device as part of the financial transaction.

3. The secured hardware token of claim 1,
wherein the data in secured persistent storage further comprises:
a separate unique master secret for a plurality of products from a plurality of goods/services providers;
wherein the security application is further configured to cause the embedded processor to:
receive from a product application executing on the mobile device, a second call for a second n-bit result, wherein the second call comprises a second n-bit generator input and a second master secret identifier corresponding to the product application;
obtain, from the secured persistent storage on the secured hardware token, a corresponding master secret referenced by the second master secret identifier;
construct, by the n-bit generator executing on the secured hardware token, the second n-bit result specific to the second call using the corresponding master secret and the second n-bit generator input as input to the n-bit generator; and
return the second n-bit result to the product application.

4. The secured hardware token of claim 3, wherein the security application comprises:
a configuration utility for configuring the secured hardware token.

5. The secured hardware token of claim 4, wherein configuring the secured hardware token comprises:
receiving, from a goods/services provider of a plurality of goods/services providers, a seed encrypted using a user's public key;
decrypting the seed using a corresponding private key;
generating, by the n-bit generator, the corresponding master secret using the seed as input; and
storing the master secret in the secured persistent storage.

6.-22. (canceled)

23. The secured hardware token of claim 1, wherein the secured hardware token is embodied in a Secured Digital (SD) card.

24. The secured hardware token of claim 2, wherein the secured hardware token is embodied in a Secured Digital (SD) card.

25. The secured hardware token of claim 3, wherein the secured hardware token is embodied in a Secured Digital (SD) card.

26. The secured hardware token of claim 4, wherein the secured hardware token is embodied in a Secured Digital (SD) card.

27. The secured hardware token of claim 5, wherein the secured hardware token is embodied in a Secured Digital (SD) card.
